(19) United States
(12) Patent Application Publication
(10) Pub. No.: US 2013/0243989 A1
(43) Pub. Date: Sep. 19, 2013

(54) Lattice Support Structure

(71) Applicant: SIGMA-TEK, LLC, Lindon, UT (US)

(72) Inventors: Michael D. Ridges, Lindon, UT (US); Erich A. Wilson, Lindon, UT (US); Michael D. Kipp, Lindon, UT (US)

(73) Assignee: Sigma-Tek, LLC, Lindon, UT (US)

(21) Appl. No.: 13/732,250

(22) Filed: Dec. 31, 2012

Related U.S. Application Data
(60) Provisional application No. 61/582,207, filed on Dec. 30, 2011.

(51) Int. Cl. B29C 53/56; B32B 1/08

(52) U.S. Cl. CPC B29C 53/566; B32B 1/08
USPC 428/36.91; 156/161; 156/169; 156/443; 156/446

(57) ABSTRACT

The present disclosure is drawn to a lattice support structures and methods of making such structures, including tooling and articles used therein. In one embodiment, a method for forming a composite lattice support structure can comprise: obtaining a semi-rigid mold having semi-rigid channels, at least some of the semi-rigid channels intersecting at strategic locations; laying up a fiber material, in the presence of a resin, within the semi-rigid channels forming a lay-up within the semi-rigid channels, such that the lay-up extends above the surface of the mold; consolidating the lay-up to form composite cross supports having a pre-determined lateral cross-sectional area controlled by a cross-sectional area of the channels, and that intersect to form nodes, thereby forming the composite lattice support structure; and subjecting the composite lattice support structure to a particulate, wherein the composite lattice support structure is at least partially submerged in the particulate and systematically rotated to cause the particulate to contact the various surfaces of the cross supports and nodes thereby reducing at least of portion of material on the surfaces.

### RELATED APPLICATIONS

This application claims the benefit of U.S. Provisional Application Ser. No. 61/582,207, filed Dec. 30, 2011, which is incorporated by reference herein in its entirety.

### BACKGROUND

Structural supports, including lattice-type structural supports, have been developed for many applications which provide high strength performances, but benefit from the presence of less material. In other words, efficient structural supports can possess high strength, and at the same time, be low in weight resulting in high strength/weight ratios. Truss systems have been pursued for many years and continue to be studied and redesigned by engineers with incremental improvements.

In the field of carbon fiber lattice support structures, a primary issue concerning such systems relates to the formation of such structures to achieve high performance properties that would allow the structure to be viable in the marketplace. In addition, existing manufacturing methods have proven extremely costly and/or inadequate to produce a viable structure.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIGS. 1A-1C depict exemplary embodiments of lattice support structures in accordance with embodiments of the present disclosure;

FIGS. 2A-2C depict alternative exemplary embodiments of lattice support structures in accordance with embodiments of the present disclosure;

FIGS. 3A-3C depict alternative exemplary embodiments of lattice support structures in accordance with embodiments of the present disclosure;

FIGS. 4A-4C depict alternative exemplary embodiments of lattice support structures in accordance with embodiments of the present disclosure;

FIG. 5 depicts an alternative exemplary embodiment of another lattice support structure in accordance with embodiments of the present disclosure;

FIGS. 6A-6F depict various illustrative or graphical arrangements of cross supports and various node configurations in accordance with embodiments of the present disclosure;

FIG. 7 depicts a multi-layered node configuration prior to fusion and/or consolidation in accordance with embodiments of the present disclosure, where each cross support includes multiple layers and the layers are stacked with other cross support material from different cross supports there between at the node;

FIG. 8 depicts node layering in cross section in accordance with one embodiment of the present disclosure;

FIG. 9 depicts node layering in cross section in accordance with another embodiment of the present disclosure;

FIG. 10 depicts a cutaway portion of an exemplary consolidated node in accordance with embodiments of the present disclosure;

FIG. 11 depicts an exemplary consolidated node sectioned orthogonally to the longitudinal axis depicting the change in member width approaching the node and massing of layered material near and on or at the node;

FIGS. 12A-12D depict alternative exemplary embodiments of cross-sectional geometries of individual cross supports;

FIGS. 13A-13F depict still further alternative exemplary embodiments of cross-sectional geometries of individual cross supports;

FIGS. 14A-14C depict an exemplary lattice support structure having a plurality of longitudinal and helical cross supports, wherein at least some of the longitudinally oriented cross supports comprise a t-shaped cross-sectional geometry;

FIG. 15 depicts a graphical representation of a partial cross-sectional view of a system used to fabricate a lattice support structure in accordance with an exemplary embodiment of the present invention;

FIG. 16 depicts a individual mold segment having grooves formed therein that can be used with other similar mold segments to form a semi-rigid mold in accordance with one exemplary embodiment;

FIG. 17 depicts a semi-rigid mold formed from individual mold segments such as the one illustrated in FIG. 16, wherein the semi-rigid mold is supported about or installed on a rigid mandrel in accordance with one exemplary embodiment;

FIG. 18 depicts a partial view of the semi-rigid mold and mandrel arrangement of FIG. 17 with fiber material laid up on the semi-rigid mold, in accordance with one exemplary embodiment;

FIG. 19-A depicts a partial side view of a semi-rigid mold having grooves formed therein, in accordance with one exemplary embodiment;

FIG. 19-B depicts a graphical partial end or cross-sectional view of a semi-rigid mold as supported about a mandrel, in accordance with one exemplary embodiment;

FIGS. 19-C-19-E depict different variations of extension members of a semi-rigid mold, in accordance with exemplary embodiments;

FIG. 20 depicts an exploded view of a cutting tool in accordance with one exemplary embodiment;

FIG. 21 depicts a flow diagram of a method for forming grooves within a semi-rigid mold material;

FIG. 22 depicts a flow chart of an exemplary fabrication method;

FIG. 23 depicts a flow chart of another exemplary fabrication method;

FIG. 24 depicts a flow chart of an exemplary laying up process;

FIG. 25 depicts a flow chart of an exemplary consolidation process;

FIG. 26 depicts a perspective view of a finishing system for finishing an object such as a lattice support structure, in accordance with one exemplary embodiment;

FIG. 27 depicts an end view with a partial cut-away of the finishing system of FIG. 26;

FIG. 28 depicts a cross-section of the finishing system of FIG. 26;

FIG. 29 depicts a graphical representation of a particulate caused to contact all sides of a lattice support structure during a finishing process using the finishing systems described herein;

FIG. 30 depicts a perspective end view of a finishing system for finishing a lattice support structure in accordance with another exemplary embodiment; and

FIG. 31 depicts a partial side view of the finishing system of FIG. 30.

Reference will now be made to the exemplary embodiments illustrated, and specific language will be used herein to describe the same. It will nevertheless be understood that no limitation of the scope of the invention is thereby intended.

### DETAILED DESCRIPTION

The following detailed description of representative embodiments of the present disclosure makes reference to the accompanying drawings, which form a part hereof and in which are shown, by way of illustration, various representative embodiments in which the teachings of the disclosure can be practiced. While these embodiments are described in sufficient detail to enable those skilled in the art to practice the disclosure, it should be understood that other embodiments can be realized and that various changes can be made to the disclosure without departing from the spirit and scope of the present invention. As such, the following detailed description is not intended to limit the scope of the disclosure as it is claimed, but rather is presented for purposes of illustration, to describe the features and characteristics of the present disclosure, and to sufficiently enable one skilled in the art to practice the disclosure. Accordingly, the scope of the present invention is to be defined by the appended claims.

The following detailed description and exemplary embodiments of the invention will be best understood by reference to the accompanying drawings, wherein the elements and features of the invention are designated by numerals throughout.

At the outset, the term “fiber-based composite material” shall be understood to mean a material comprised at least of carbon or other fiber (e.g., a carbon or glass fiber filament) and resin (e.g., polymer matrix) constituents.

When referring to a “multi-layered” node, what is meant is that the cross supports are not merely stacked on top of one another, but rather, a first individual cross support has multiple layers with one or more layer(s) of material from other cross supports therebetween. Thus, in order to be “multi-layered, there must be at least one cross support or layer of at least one cross support that is between at least two layers of another cross support. Typically, however, each cross support of the node is layered with other cross support layers therebetween (as shown hereinafter in FIG. 7). The term “multi-layered” node may also be described as one or more selective individual fiber filaments of one cross support intersecting and being layered with one or more individual selective fiber filaments of at least one other cross support.

As used herein, “B-stage” refers to a product that is partially cured and becomes fully cured upon heating.

As used herein, “polymeric material” refers to materials comprised of polymers that contract or that undergo negative thermal expansion when subjected to heat, such as for the purpose of inducing or applying a pressure to an adjacent component or material.

The term “preform” shall be understood to mean the green, uncured composite lay-up comprising the fiber material and resin composite as situated about the mold, and that has undergone preliminary shaping but is not yet in its final consolidated or cured form.

The term “semi-rigid mold” shall be understood to mean a mold comprised of a flexible, bendable non-rigid material (i.e., unlike metals) having one or more channels or grooves formed therein, that undergoes a degree of thermal expansion when subjected to increased temperatures suitable to facilitate consolidation of fiber materials deposited thereon. One example of a material suitable for a semi-rigid mold is a B-stage silicone that has been fully cured prior to the channels or grooves being formed therein.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter

In accordance with this, a lattice support structure can comprise a plurality of fiber-based cross supports intersecting one another to form a multi-layered node. The multi-layered node can be consolidated within a groove of a rigid mold in the presence of resin, heat, and pressure. In one embodiment, the cross supports can have a thickness where the multi-layered node is thinner than the sum of the thickness of each cross support at the multi-layered node.

In another embodiment, a lattice support structure can comprise a first cross support comprising fiber material, and a second cross support comprising a fiber material, where the second cross support intersects the first cross support. The lattice support structure can also include multi-layered nodes located where the first cross support intersects the second cross support. The multi-layered nodes can comprise at least two layers of the first cross support separated by a least one layer of the second cross support. Additionally, at least one of the first cross support or the second cross support can be curved from node to node.

It is notable that the present disclosure provides lattice support structures or fiber-based composite articles. Examples of other specific methods for the fabrication thereof and related devices and systems can be found in Applicants' copending U.S. Patent Applications including Ser. No. 12/542,442 filed Aug. 17, 2009; Ser. No. 12/542,555 filed Aug. 17, 2009; Ser. No. 12/542,613 filed Aug. 17, 2009; Ser. No. 12/542,607 filed on Aug. 17, 2009; Ser. No. 13/108,873 filed May 16, 2011 each of which is incorporated herein by reference in its entirety.

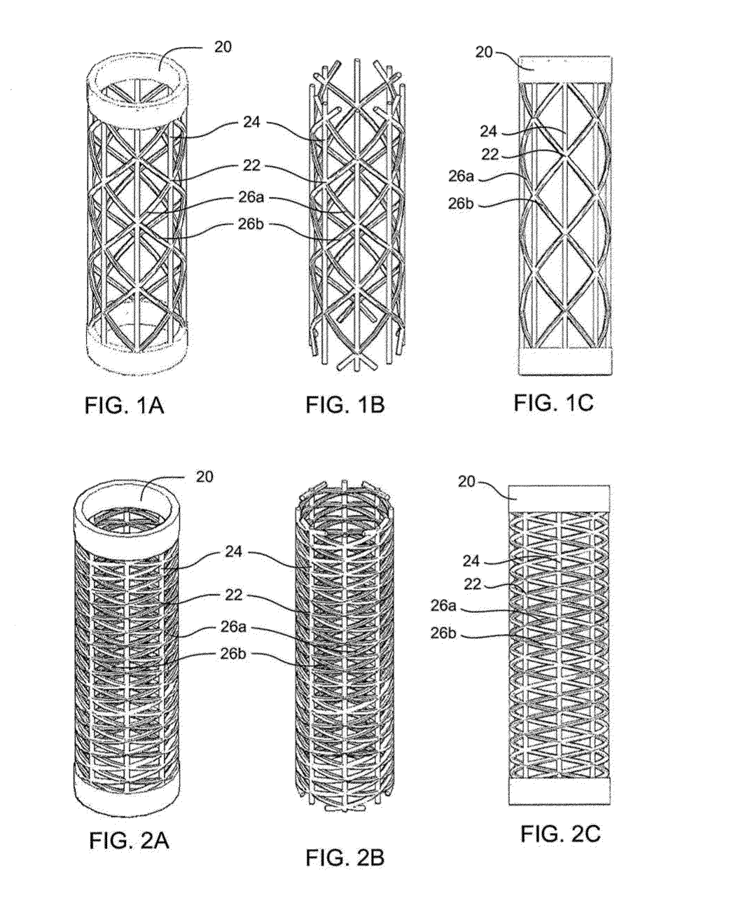

With specific reference to FIGS. 1A, 1B, and 1C, one embodiment of a lattice support structure is shown. FIG. 1A and FIG. 1C are identical, showing different views of the same structure. FIG. 1B is identical to FIG. 1A, except that it does not include optional support collars 20 on each end of the lattice support structure. The optional support collars can include the base plates and caps as discussed herein. These lattice support structures each comprise a plurality of fiber-based cross supports intersecting one another to form several multi-layered nodes 22. It is noted that there are eight longitudinal cross supports 24 and eight helical cross supports 26a, 26b (four twisting clockwise 26a from top to bottom and four twisting counterclockwise 26b from top to bottom). Nodes are formed in this embodiment where three cross supports (one longitudinal cross support, one clockwise helical cross support, and one counterclockwise helical cross support) intersect. The helical cross supports form curved node-to-node cross support segments. This structure also demonstrates four helical cross supports taken at a one turn per seven inches pitch, with four counter wrapped helical cross supports of equal pitch combined with longitudinal cross supports, coupled at a plurality of multi-layered nodes where the ends have been consolidated with a collar. It is noted that this structure profile, including number and direction of turns, number and position of various cross supports, etc., is merely exemplary, and can be modified slightly or significantly in accordance with embodiments of the present disclosure.

With specific reference to FIGS. 2A, 2B, and 2C, another embodiment of a lattice support structure is shown. FIG. 2A and FIG. 2C are identical, showing different views of the same structure. FIG. 2B is identical to FIG. 2A, except that it does not include optional support collars 20 on each end of the lattice support structure. These lattice support structures each comprise a plurality of fiber-based cross supports intersecting one another to form several multi-layered nodes 22. It is noted that there are eight longitudinal cross supports 24 and eight helical cross supports 26a, 26b (four twisting clockwise 26a from top to bottom and four twisting counterclockwise 26b from top to bottom). In some embodiments, the number of helical cross supports in each direction, left and right hand, can be equal to the number of longitudinal cross supports. Nodes are formed in this embodiment where three cross supports (one longitudinal cross support, one clockwise helical cross support, and one counterclockwise helical cross support) intersect. The helical cross supports form curved node-to-node cross support segments. It is noted that the primary difference between the structures shown in FIGS. 1A-1C and the structures shown in FIGS. 2A-2C is the increased frequency of twists for the helical lattice support structures in FIGS. 2A-2C. This structure also demonstrates 4 helical cross supports taken at a five turns per seven inches pitch, with four counter wrapped helical cross supports of equal pitch combined with longitudinal cross supports, coupled at a plurality of multi-layered nodes where the ends have been consolidated by a collar.

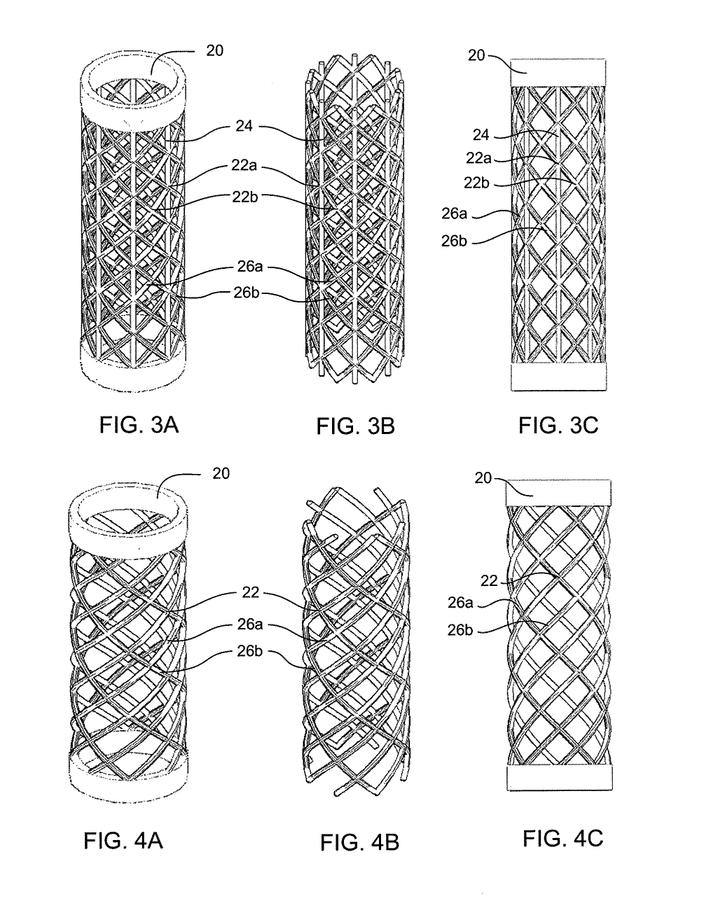

With specific reference to FIGS. 3A, 3B, and 3C, another embodiment of a lattice support structure is shown. FIG. 3A and FIG. 3C are identical, showing different views of the same structure. FIG. 3B is identical to FIG. 3A, except that it does not include optional support collars 20 on each end of the lattice support structure. These lattice support structures each comprise a plurality of fiber-based cross supports intersecting one another to form several multi-layered nodes 22a, 22b. Again, it is noted that there are eight longitudinal cross supports 24. However, in this embodiment, there are sixteen (16) helical cross supports 26a, 26b (eight twisting clockwise 26a from top to bottom and eight twisting counterclockwise 26b from top to bottom). Also, in this embodiment, two different types of multi-layered nodes are formed. First, multi-layered nodes 22a are formed where three cross supports (one longitudinal cross support, one clockwise helical cross support, and one counterclockwise helical cross support) intersect. Multi-layered nodes 22b are also formed where two helical cross supports (one clockwise helical and one counterclockwise helical) intersect without a longitudinal cross support. This structure also demonstrates eight helical cross supports taken at a two turns per seven inches pitch, with eight counter wrapped helical cross supports of equal pitch combined with longitudinal cross supports, coupled at a plurality of multi-layered nodes where the ends have been consolidated by a collar. It is also noted that additional multi-layered nodes are present that do not include longitudinal cross supports.

With specific reference to FIGS. 4A, 4B, and 4C, another embodiment of a lattice support structure is shown. FIG. 4A and FIG. 4C are identical, showing different views of the same structure. FIG. 4B is identical to FIG. 4A, except that it does not include optional support collars 20 on each end of the lattice support structure. These lattice support structures each comprise a plurality of fiber-based cross supports intersecting one another to form several multi-layered nodes 22. In this embodiment, there are no longitudinal cross supports. Also in this embodiment, there are twelve (12) helical cross supports 26a, 26b (four twisting clockwise 26a from top to bottom and eight twisting counterclockwise 26b from top to bottom). This embodiment thus also demonstrates the ability to design for unidirectional torsion and other loads through varying the number of members in the clockwise direction from those in the counterclockwise direction. Nodes 22 are formed where two helical cross supports (one clockwise helical cross support and one counterclockwise helical cross support) intersect without a longitudinal cross support.

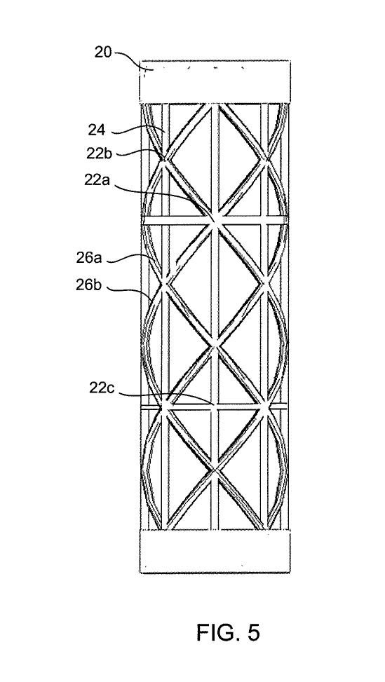

With specific reference to FIG. 5, another embodiment of a lattice support structure is shown. In this FIG., not only are longitudinal cross supports 24 and helical cross supports 26 shown, but circumferential cross supports 28 are also shown. Again, these lattice support structures each comprise a plurality of fiber-based cross supports intersecting one another to form several multi-layered nodes 22a, 22b, 22c. In this embodiment, there are eight helical cross supports and eight longitudinal cross supports, as described previously in FIGS. 1A-1C. However, there are also two additional circumferential cross supports. Thus, in this embodiment, there are three different multi-layered node configurations. First, multi-layered nodes 22a are formed where four cross supports (one longitudinal cross support, one circumferential cross support, one clockwise helical cross support from top to bottom, and one counterclockwise helical cross support from top to bottom) intersect. Multi-layered nodes 22b are also formed where three cross supports (one longitudinal cross support, one clockwise helical cross support from top to bottom, and one counterclockwise helical cross support from top to bottom) intersect. Next, multi-layered nodes 22c are formed where two cross supports (one longitudinal cross support and one circumferential cross support) intersect.

It is noted that FIGS. 1A to FIG. 5 are provided for exemplary purposes only, as many other structures can also be formed in accordance with embodiments of the present disclosure. In other words, different lattice support structures as disclosed herein can be engineered and formed to provide or meet different and specific performance needs, which needs may be pre-determined. For example, twist pitch can be modified for helical cross supports, longitudinal cross supports can be added symmetrically or asymmetrically, circumferential cross supports can be added uniformly or asymmetrically, node locations and/or number of cross supports can be varied, as can the overall geometry of the resulting part including diameter, length and the body-axis path to include constant, linear and non-linear resulting shapes as well as the radial path to create circular, triangular, square and other polyhedral cross-sectional shapes, with or without standard rounding and filleting of the corners, etc. In other words, these lattice supports structures are very modifiable, and can be tailored to a specific need. For example, if the weight of a lattice support structure needs to be reduced, then cross lattice support structures can be removed at locations that will not experience as great of a load. Likewise, cross lattice support structures can be added where load is expected to be greater. In still other examples, lattice support structures of the present invention can be engineered to enhance or be more resistant to torsional, compressive, bending, shear, or other loads, where needed.

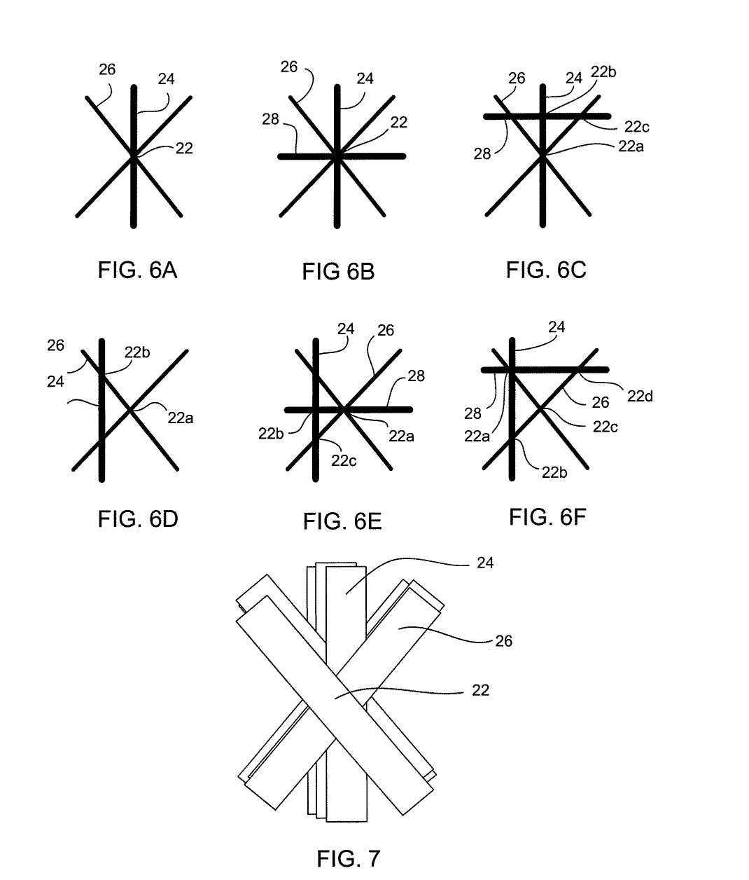

In accordance with this, FIGS. 6A-6F provide exemplary relative arrangements for helical, longitudinal, and circumferential cross supports that can be used in forming lattice support structures. Various node placements are also shown in these FIGS. FIG. 6A depicts a longitudinal cross support 24 and helical cross supports 26, forming a multi-layered node 22 at the intersection of all three cross supports. This is similar to that shown in FIGS. 1A-3C and 5. FIG. 6B depicts a longitudinal cross support 24, helical cross supports 26, and a circumferential cross support 28 forming a multi-layered node 22 at the intersection of all four cross supports. FIG. 6C depicts a longitudinal cross support 24, helical cross supports 26, and a circumferential cross support 28 forming three different types of multi-layered nodes 22a, 22b, 22c. FIG. 6D depicts a longitudinal cross support 24 and helical cross supports 26 forming two different types of multi-layered nodes 22a, 22b. FIG. 6E depicts a longitudinal cross support 24, helical cross supports 26, and a circumferential cross support 28 forming three different types of multi-layered nodes 22a, 22b, 22c. It is noted that this arrangement provides two multi-layered nodes that are similar to FIG. 6C (22a, 22b) and one that is different (22c). Specifically, multi-layered node 22c in FIG. 6C comprises a circumferential cross support and a helical cross support, whereas multi-layered node 22c in FIG. 6E comprises a longitudinal cross support and a helical cross support, thus illustrating the flexibility of design of the lattice support structures of the present disclosure. FIG. 6F depicts a longitudinal cross support 24, helical cross supports 26, and a circumferential cross support 28 forming four different types of multi-layered nodes 22a, 22b, 22c, 22d.

Turning to FIG. 7, more detail is provided with respect to forming multi-layered nodes in accordance with embodiments of the present disclosure. Specifically, for illustrative purposes only, the multi-layered node 22 shown in FIG. 6A is shown in more detail prior to heat and/or pressure fusion or consolidation. As can be seen in this embodiment, a longitudinal cross support 24 and two helical cross supports 26 are shown. Specifically, each cross support comprises multiple layers, and at the multi-layered node, each layer is separated from a previously applied layer by at least one other cross support layer. In this manner, a multi-layered node is formed that can be cured in accordance with embodiment of the present disclosure.

With specific reference to curing, in one embodiment, the curing process comprises heating at 250-350° F. for a soak period of about 10 to 240 minutes depending on the size of the part and its coinciding tooling. In this embodiment, the fiber material and resin members with layered and interleaved nodes can be applied to a semi-rigid mold and wrapped with a polymeric material. Once in place, the pressure from the polymeric material from the top and expanding semi-rigid mold along the sides and some from the bottom of the fiber material and resin members provides pressure on multiple sides, thus curing and consolidating the members into the desired cross supports and multi-layered nodes. In one specific embodiment, the temperature can be between 300-350° F. for a period of about 30 minutes to 90 minutes. This and other exemplary methods for forming lattice support structures are described in further detail below.

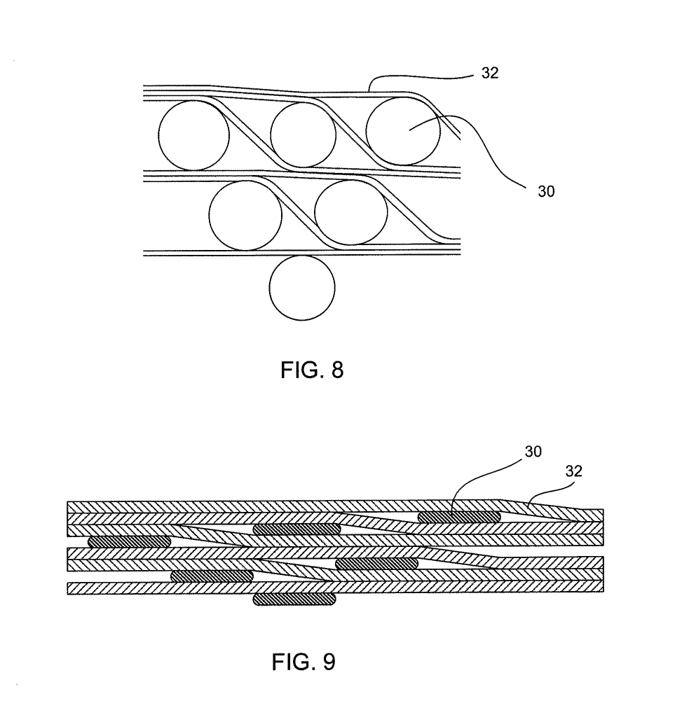

FIGS. 8 and 9 depict schematic representations of possible multi-layered node structures. Specifically, FIG. 8 depicts layering using tow material of low fiber count and what a nodal cross-section might appear to be like before consolidation and FIG. 9 depicts what the layering would appear like after consolidation. It is noted that the fiber of high fiber-count tow or tape products may appear like FIG. 9 prior to consolidation as well, and after consolidation, the node would appear even more flattened in shape. In these FIGS., it is assumed that six layers of tow or tape are wrapped to demonstrate the leaving of layers in the nodes. In each of these two figures, the cross supports shown on end (along the Z-axis) in cross-section 30 can be assumed to be members which continue into and out of the respective FIG. The cross support material 32 intersecting them (along the X- and Y-axis) represent a single cross-support members, and collectively, these cross supports form nodes of the shape similar to 22b, 22c and 22d in FIGS. 6E and 6F. In these illustrations, the helical cross support is approaching from the left side. Were there to be an additional helical member wrapped in the opposite direction, it would look to be the mirror image of the one shown and approach from the right side of the figures.

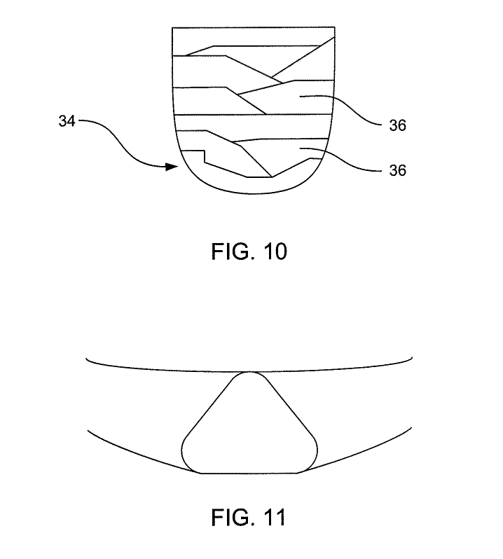

FIG. 10 sets forth a cutaway cross-section of a multi-layered node after curing and consolidation of the layered material. Note the cross-sectional area of the member is set into a half-pipe geometry 34 (as consolidated and forced in half-pipe shaped grooves from a semi-rigid mold), though other geometries are certainly a design option, depending on the shape of the grooves. For example, in one embodiment, the grooves can comprise a V-channel. This consolidated node structure shows a distinction in structure compared to the prior art junctions where weaving and/or braiding are used. Most notably, a build-up of material in the node resulting from coupling the material from various members in various directions allows for the forming of a consolidated node that is compacted and cured, adding strength to the overall structure. Rather than stacking each layer directly on top of the next, the leaving as in FIGS. 8 and 9 allows for individual wraps 36 of tow or tape to end up side-by-side and stacked as a function of the geometry they are forced into before curing. Likewise, FIG. 11 sets forth an exemplary consolidated node sectioned orthogonally to the longitudinal axis depicting the change in member width approaching the node and massing of layered material near and on the node as just described.

In further detail with respect to the embodiments shown in FIGS. 1-11, the present disclosure relates to helical cross supports wrapped around a centerline where the helical cross supports have curved segments rigidly connected end to end and layered with or without axial, radial, or laterally configured lattice support structures (e.g., longitudinal and/or circumferential cross supports) which can be straight or curved end to end. The curves of the helical cross support segments can comply directly with the desired geometric shape of the overall unit. In one embodiment, the structure can include at least two helical cross supports. As described above, at least one of the helical cross supports wraps around the centerline in one direction (clockwise from top to bottom, for example) while at least one other wraps around in the opposite direction (counterclockwise from top to bottom, for example). Though a “top to bottom” orientation is described, this is done for convenience only, as these structures may be oriented other than in a vertical configuration (horizontal, angular, etc.). Helical cross supports wrapped in the same direction can have the same angular orientation and pitch, or can have different angular orientations and pitch. Also, the spacing of the multiple helical cross supports may not necessarily be spaced apart at equal distances, though they are often spaced at equal distances. The reverse helical cross supports can be similarly arranged but with an opposing angular direction. These helical cross supports can cross at multi-layered nodes, coupling counter oriented helical cross supports through layering of the filaments. This coupling provides a ready distribution of the load onto the various structural supports. When viewed from centerline, the curving segments of the components can appear to match the desired geometry of the structural unit with no significant protrusions, i.e. a cylindrical unit appears as a circle from the centerline. In this embodiment, all components can share a common centerline.

Additional structural supports can also be included in the lattice support structure. Components which are straight from junction to junction may be included to intersect multi-layered nodes parallel to the centerline to form other members (e.g. longitudinal cross supports). Components, which can be curved or straight, can also be added circumferentially to intersect with the multi-layered nodes along the length of the lattice support structure. These circumferential cross supports can be added to increase internal strength of the structure. These additional members may be added to intersect at the multi-layered nodes, but do not necessarily need to intersect the nodes formed by the helical cross supports crossing one another, e.g. they may cross at areas between helical-helical nodes. In other words, the longitudinal cross supports and/or the circumferential cross supports may form common multi-layered nodes with helical-helical formed multi-layered nodes, or can form their own multi-layered nodes between the helical-helical formed multi-layered nodes. In either case, the multi-layered nodes can still be formed using filament layering. The count of helical members compared to other members is flexible in certain embodiment to allow for multi-layered nodes to occur only as lattice support structures intersect in a given location, or to allow for multiple node locations composed of two or more, but not all of the members in the structure. The capability of such a design allows versatility in the number of helical cross supports, the coil density, as well as the number of multi-layered nodes or intersections with axial, radial, or lateral components. As a general principle, the more strength desired for an application, the higher the coil density; whereas, the less strength desired, the fewer coils and wider the wrap length per coil may be present.

Structural supports may be covered with a material to create the appearance of a solid structure, protect the member or its contents, or provide for fluid dynamic properties. Even though the structures disclosed herein are relatively lightweight, because of its relative strength to weight ratio, these lattice support structures are strong enough to act as stand-alone structural units.

In accordance with one embodiment, the present disclosure can provide a lattice support structure where individual cross supports are wrapped with uni-directional tow, where each cross support comprises continual strands extending in the same direction. Further, it is notable that an entire structure can be wrapped with a single strand, though this is not required. Also, the lattice support structures are not weaved or braided, but rather, can be wrapped layer by layer (these also being unidirectional and parallel to one another) where a leaving structure is created in the nodes. Thus, where the helical cross supports intersect one another and/or one or more longitudinal and/or circumferential cross supports, these intersections create multi-layered nodes of compounded material which couple the members together. In one embodiment, the composite strand does not change major direction at these multi-layered nodes to form any polyhedral shape when viewed from the axial direction. FIG. 11 as a cross section of a longitudinal member depicts the bending of the helical members intended in this disclosure. This is also evident in FIGS. 1-5 through the creation of cylindrical parts using this technology. Thus, the strand maintains their path in its own axial, circumferential, or helical direction based on the geometry of the part. Once wrapped in this manner, the entire part can be cured and/or fused as described herein or by other methods, wherein consolidation takes place to form the cross supports and multi-layered nodes.

It is also noted that these lattice support structures can be formed using a semi-rigid mold, which can be supported by a solid mandrel. In one aspect, the semi-rigid mold can comprise grooves formed or embedded therein for receiving filament or fiber materials (and resin) when forming the lattice supports structure. Being produced in this fashion allows the cross supports of the structural unit to be round, triangular or square or any sectional form of these including, but not limited, to rounding one or more corners. For production, the filaments can be wrapped around the semi-rigid mold generally conforming to the desired patterns of the members and providing a supportive geometric base for the structure during production, which mold can be supported by a solid mandrel. In one aspect, the solid mandrel can comprise a break-away or collapsible mandrel. In another aspect, the mandrel can be a solid non-break-away or collapsible structure. Though a secondary wrap, e.g., KEVLAR, may be applied once the structure has been cured or combined with the primary fibers before cure, consolidation of members can be achieved through covering the uncured structure with a polymeric material and heating the wrapped structure, thereby creating pressure over multiple sides of the filaments and the to-be-formed cross supports and multi-layered nodes. Heat and pressure can be applied sufficiently to effectuate curing of the filaments. This adds strength to the overall formed support structure through allowing segments of components to be formed from a continuous filament, while also allowing the various strands in a single member, or the various strands in multiple members at the nodes, to be consolidated during curing.

Turning now to more specific detail regarding consolidation of the multi-layered nodes, it has been recognized that the closer the fibers are held together, the more they act in unison as a single piece rather than a group of fibers. In composites, resin can facilitate holding the fibers in close proximity to each other both in the segments of the cross supports themselves, and at the multi-layered nodes when more than one directional path is being taken by groups of unidirectional fibers being layered. In filament winding systems of the present disclosure, composite tow or tape (or other shaped filaments) can be wound and shaped using a semi-rigid mold, covered with a polymeric or other material capable of negative thermal expansion to apply top-down pressure to the filaments within the semi-rigid mold, and then the composite fibers can be forced together by applying pressure created by subjecting the wound filament, the semi-rigid mold, and the polymeric material to heating. The pressure and heat can be used to fuse the multi-layered nodes, generating a tightly consolidated multi-layered node. Thus, the multi-layered node is held in place tightly using pressure, and under pressure, the multi-layered node (including the filament or tow material and the resin) can be heat fused or cured, making the multi-layered node more highly compacted and consolidated than other systems in the prior art. By using a semi-rigid mold with specifically cut paths for the unidirectional fiber to be laid into, the fibers that will form the cross supports and the multi-layered nodes are held in place and compacted during the consolidation process. In short, consolidation control using a semi-rigid mold, pressure over the wound filament or fibers by way of a polymeric material, and resin/heat curing provides high levels of consolidation that strengthen the lattice as a whole.

One specific feature of a lattice support structure formed with the semi-rigid mold and polymeric wrap(s) (which may also be considered semi-rigid components) described herein is highly consolidated cross supports and nodes, and particularly node edges. The lattice support structures of the present invention have substantially complete consolidation (between 94% and 98% consolidated; or a void content of between 2%-5%) due to the reduction and substantially complete elimination of gaps, holes, bubbles, voids, etc. at the nodes. This is achieved by the use of the semi-rigid mold and the polymeric wrap(s). During consolidation, as the semi-rigid mold and the polymeric wrap apply a pressure from all sides to compact the fiber materials, the semi-rigid mold also facilitates bulging of the fiber materials at the nodes about at least one surface or sidewall, as well as the bottom. In addition, the polymeric wrap permits bulging at the top. Depending upon the configuration and make-up of the semi-rigid mold and the polymeric wrap, bulging may or may not be consistent about all surfaces. Moreover, the semi-rigid mold and polymeric wrap combination facilitates some degree of spreading of the fibers at the nodes, such that the formed lattice structure comprises a node having bulging along the top and sides, as well as a spread configuration. This feature is due to the semi-rigid nature of both of the semi-rigid mold and the polymeric wrap. Specifically, as the semi-rigid mold undergoes thermal expansion it takes the shape of the node and conforms on all points to the deposition of the fibers within the node (unlike a rigid mold that does not expand or conform). Similarly, as the polymeric wrap undergoes negative thermal expansion, it too takes the shape of the node and conforms to the semi-rigid mold and the fiber materials. This occurs both at the nodes and the cross supports. The semi-rigid mold and polymeric wrap conform to a degree so as to eliminate any gaps between fiber materials and the semi-rigid mold and the polymeric wrap. As a result, these each apply pressure at all points to compact the fiber materials, with greater pressures being applied at the nodes due to the significant amount of fiber material (and resin) in the nodes compared to any individual cross support. The combined bulging and spreading of the fiber materials at the node produce a higher consolidation percentage at the nodes, and particularly at the edges of the nodes where the cross supports come into the nodes. The edges of the nodes in prior composite structures tends to be a weak point or location. However, using the semi-rigid mold and the polymeric wrap provides consolidation sufficient to strengthen the edges of the nodes so that these are not a weak point. When you combine the ability of the semi-rigid mold and the polymeric wrap to produce higher consolidated nodes with little or no voids at the edges with the fact that the entire lattice support structure can be made of unidirectional fiber materials (cross supports having fibers oriented in a single direction), the result is a high performance structure that is efficient to manufacture.

The semi-rigid mold can be manufactured or formed from a material having a hardness and expansion property sufficient to thermally expand to create pressure on the fibers from multiple directions when the fibers and the mold are wrapped in a polymeric material and heated. In one embodiment, the semi-rigid mold can have a Shore hardness of 40 A to 60 A. In one embodiment, the semi-rigid mold can comprise silicone having a Shore A hardness of 60 A. In one aspect, the silicone can be B-stage silicone having a linear coefficient of thermal expansion of 1.7×10⁻⁴ in/in/F (200-300 micrometer/m° C.). The present process can eliminate the need of expensive and cumbersome bagging systems, and can provide for faster production and increased efficiency.

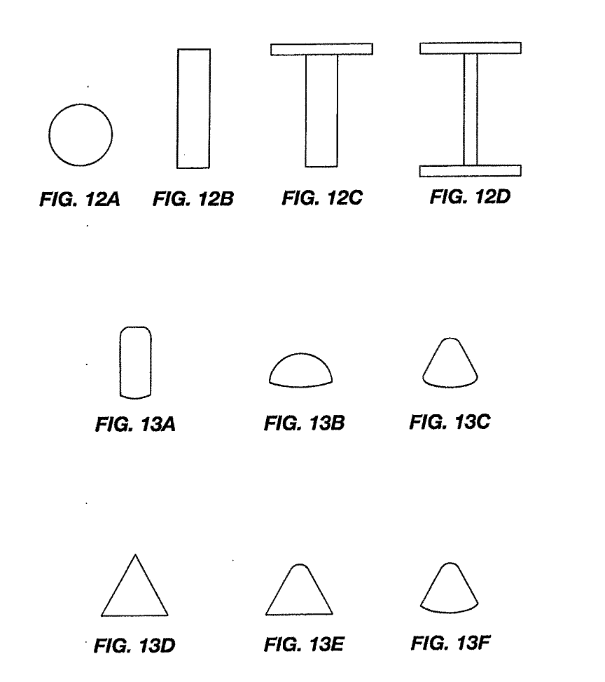

In addition, there are other advantages of the system described herein, namely the ability to manipulate the cross-sectional geometry of the cross sectional shape of the individual cross supports. As a function of the semi-rigid mold, solid mandrel and polymeric materials, forcing the fibers into the cut or otherwise formed grooves of the semi-rigid mold allows for the geometry of the cross supports to be modified in cross-section. Any geometry which can be applied to the grooves of the semi-rigid mold can be used to shape resulting cross supports and can range from square/rectangular to triangular, half-pipe, or even more creative shapes. For example, individual cross supports may comprise a cross-sectional area that is round (see FIG. 12A), rectangular (see FIG. 12B), T-shaped or flanged (see FIG. 12C), I-beam shaped or double flanged (see FIG. 12D), or virtually any other shape or configuration. This provides the ability to control or manipulate the moment of inertia of the cross support members. With the use of a semi-rigid mold, solid mandrel, pressure application, and resin/temperature curing, measurement has shown that geometric tolerances can be kept at less than 0.5%.

FIGS. 13A-13F further illustrate that these cross-sectional shapes or configurations may further comprise rounded corners, as well as linear and/or nonlinear sides, or a combination of such. For instance, FIG. 13A illustrates a cross support having a generally rectangular shape, with a flat inner surface (surface facing toward the centerline of the structural support), rounded upper corners, and a generally convex outer surface (surface facing away from the centerline). FIG. 13B illustrates a cross support having a generally half-circle cross-sectional shape, with an outer surface being generally convex. FIG. 13C illustrates a cross support having a generally triangular cross-sectional shape, with each corner being rounded. FIG. 13D illustrates a cross support having a triangular shape, with no rounded corners. FIG. 13E illustrates a cross support having a generally triangular cross-sectional shape, with an upper rounded corner, and a generally flat outer surface. FIG. 13F illustrates a cross support having a generally triangular cross-sectional shape, with an upper rounded corner, and a generally convex outer surface. The several cross-sectional areas or configurations illustrated in the FIGS and discussed herein are merely exemplary of the several configurations made possible by controlling the tooling used to produce the cross supports. By controlling the tooling, and particularly the size, geometry, etc. of the channels or grooves of the semi-rigid mold, the cross-sectional area of individual cross supports (and multi-layered nodes) can be specifically controlled and optimized for a given design. It is noted also that not all cross supports within a given lattice support structure are required to comprise the same cross-sectional area or configuration. Indeed, a lattice support structure may comprise a plurality of cross supports with different cross-sectional areas.

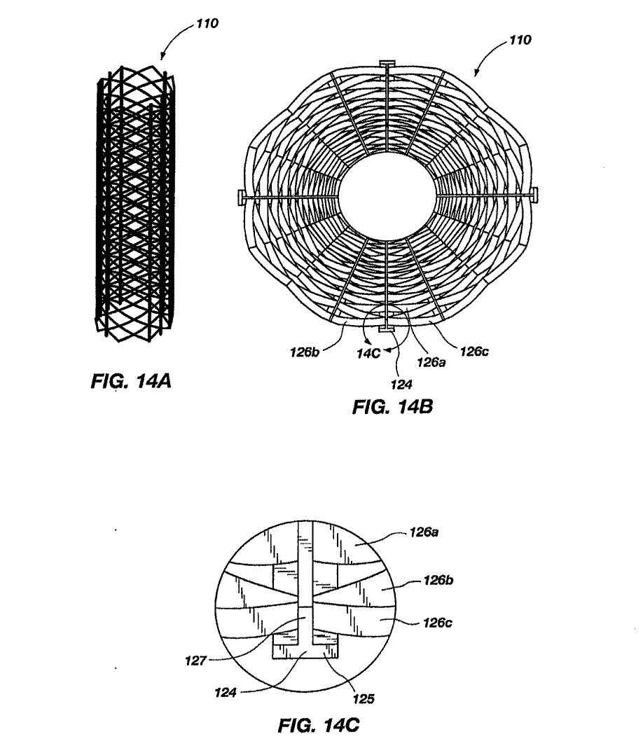

With reference to FIGS. 14A-14C, illustrated is a composite lattice support structure 110 formed in accordance with another embodiment of the present invention. FIGS. 14A and 14B illustrate a plurality of helical cross supports, including helical cross supports 126a, 126b and 126c that intersect to from various multi-layered nodes. In addition, the support structure 110 comprises a plurality of longitudinal cross supports, such as longitudinal cross support 124, some of which can comprise a T-shaped cross section. As shown, the outer surface of the T-shaped (the surface facing away from the centerline) comprises a generally flat or linear surface configuration. The inner surfaces (those facing toward the centerline) also comprise a generally flat or linear configuration. However, in this particular embodiment, rounded corners having a given radius “r” are included where the flange portion 125 intersects with the web portion 127. Of course, as described elsewhere, various other cross-sectional geometries are possible.

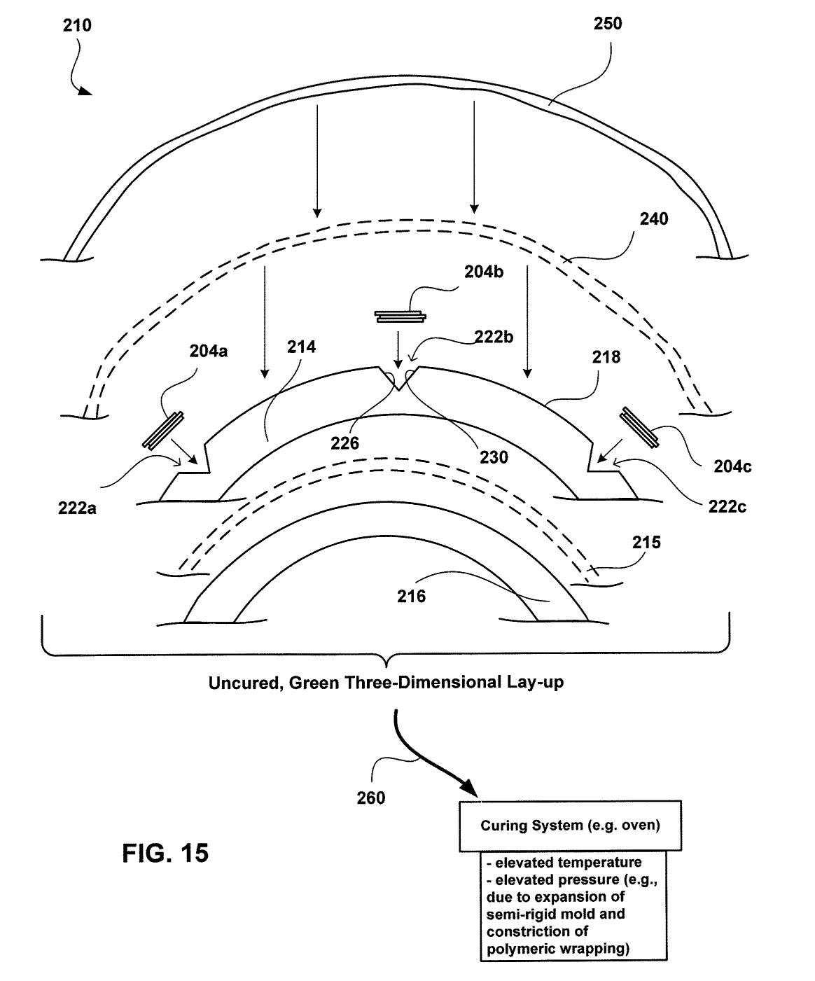

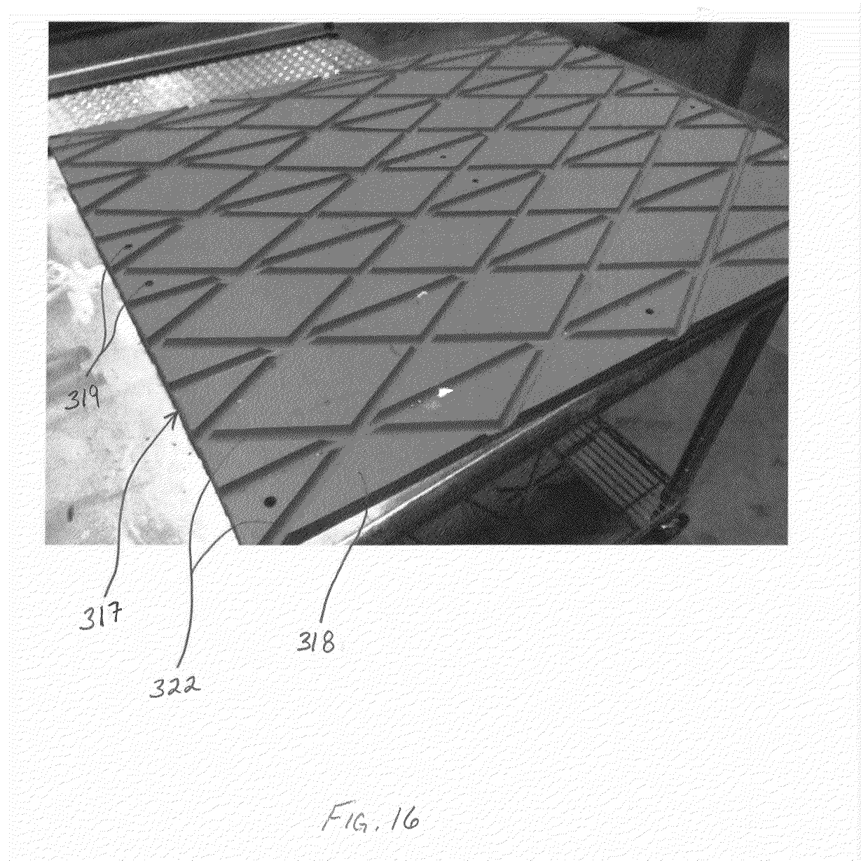

With reference to FIG. 15, illustrated is an exploded, partial cross-sectional graphical representation of a system for fabricating complex three-dimensional lattice support structures in accordance with one exemplary embodiment of the present invention. The system 210 comprises a semi-rigid mold 214 having a working surface 218 and a plurality of channels in the form of grooves (see grooves 222a, 222b, and 222c) formed in the working surface 218. The semi-rigid mold 214 can be supported by a rigid mandrel 216, such as a collapsible or non-collapsible mandrel. The grooves may be formed into the working surface 218 in various ways. In one exemplary embodiment, the grooves may be formed by subjecting the semi-rigid mold to a material reduction process (e.g., a cutting process). Of course, those skilled in the art will recognize other ways of actively forming the grooves or channels into the semi-rigid mold.

The grooves define various surface boundaries depending upon the particular cross-sectional shape desired. In the embodiment shown, the grooves comprise a triangular cross-section (when viewed in the axial or longitudinal direction of the grooves), with surfaces 226 and 230 providing the boundary of the grooves. As discussed above, the grooves may be formed in the semi-rigid mold 214 in any configuration or design that provides a lattice or lattice-type configuration. Although shown in cross-section, it is contemplated that the semi-rigid mold 214 will comprise an elongate, three-dimensional form or shape, with some grooves being helically oriented, longitudinally oriented, laterally oriented, different in length, different in cross-sectional area or geometry, etc. Whatever the desired or required configuration of the final lattice support structure, the semi-rigid mold 214 functions as the template or mold to provide such configuration. Not only does the semi-rigid mold, and particularly the grooves of the mold, define the number, type, density, orientation etc. of the various cross supports, but it also defines the same types of parameters regarding the multi-layered nodes making up the lattice support structure. Furthermore, the mold permits the cross-sectional area of the cross supports and nodes making up the structural support unit to be specifically controlled, the types specific cross-sectional areas being limited only by the limitations inherent in the formation of the grooves in the mold.

The grooves may comprise any size, type or number and are intended to extend about the outer surface of the semi-rigid mold (e.g., about the circumference of the mold when about the mandrel, as shown) in a given direction and orientation, at least some of which are caused to intersect at various strategic locations to provide the mold with, and define the lattice configuration of, the particular composite lattice support structure to be formed. In some embodiments, the semi-rigid mold facilitates the formation of a seamless, three-dimensional lay-up of fiber materials, in the presence of resin, resulting in a seamless finished three-dimensional lattice support structure. In other words, there are no joined or fused part edges present either prior to consolidation during the formation of the uncured, green lay-up, or after consolidation of the fiber material and resin components resulting in a finished or substantially finished support structure. The part is formed and cured as a seamless structure.

Additionally, an optional release liner 215 may be present between the mandrel 216 and the semi-rigid mold 214. The release liner 215 can include any material that facilitates the removal of the mold from the mandrel. In one embodiment, the release liner can comprise paper or a polymeric material.

Although shown and described as being cylindrical, the semi-rigid mold may comprise a number of different cross-sectional areas other than circular as viewed in the axial direction. For example, the semi-rigid mold may comprise a triangular, square, oval, airfoil, octagonal, hexagonal, rectangular, or arbitrary (comprising a linear or non-linear geometry, or a combination of these) cross-sectional geometry. Further, resulting structures from the present process may include various geometries having the above cross-sectional areas or combinations thereof. As such, the lattice support structures described herein can be cylindrical, rectangular, triangular, pyramidal, conical, etc.

The lay-up includes fiber materials that are deposited in the grooves 222 of the semi-rigid mold in the presence of resin. FIG. 15 illustrates one embodiment where a preimpregnated (prepreg) tow or towpreg filament is situated for deposit into the various grooves of the semi-rigid mold (see towpregs 204a, 204b, and 204c to be deposited in grooves 222a, 222b, and 222c, respectively). The towpreg may be deposited in accordance with a winding technique in which the towpreg is wound onto the semi-rigid mold within the grooves at a pre-determined tension and as the semi-rigid mold rotates about a rotational axis. The towpreg may comprise various types and sizes, and may comprise various numbers of fibers, such as a 10K tow, a 12K tow, a 50K tow, an 80K tow, etc. Fiber materials other than towpreg filaments are also contemplated for use, such as prepreg tape and others as will be apparent to one skilled in the art. In one embodiment the fiber material includes carbon fiber. In another embodiment, the fiber material includes fiber glass. In still another embodiment, the fiber material includes at least one of boron fibers, basalt fibers, or aramid fibers.

In other embodiments, fiber material that is not preimpregnated, but rather post-wetted, may also be used. For instance, a dry fiber-based tow may be subjected to a resin component in situ during a winding process as it is being deposited within the channels of the semi-rigid mold (a process sometimes referred to as “wet winding”). Compared to a prepreg, this may result in a more fluid resin being deposited about the fibers and within the grooves. A more fluid resin may improve even further the consolidation of the cross supports and nodes about the semi-rigid mold and within the grooves during the curing process, therefore improving or enhancing the properties of the lattice support structure.

The system further comprises a polymeric material 250 adapted for placement about or over the semi-rigid mold and about or over the fiber material lay-up. The polymeric material functions to apply a top-down pressure about the semi-rigid mold and the fiber material (and resin) lay-up for assisting in the consolidation of the fiber materials and resin components. The polymeric material 250 is designed to restrict the movement of the lay-up during the curing process and to constrict around the lay-up when exposed to heat thereby helping to create sufficient pressure to facilitate curing and consolidating of the fiber materials in the presence of the resin and in the presence of elevated temperature. As the polymeric material 250 constricts under heat, the semi-rigid mold is caused to expand, thereby creating additional pressure over multiple sides or surfaces of individual layered filaments of the lay-up. In other words, the fiber material and resin lay-up, as disposed within the grooves of the semi-rigid mold, is exposed to omni-directional pressure (or pressure from all sides) as applied by the polymeric material from the top and the semi-rigid mold from the sides and bottom.

Such polymeric materials can comprise a thermoplastic material such as polyolefins; fluoropolymers including FEP (fluorinated ethylene propylene), PTFE (polytetrafluoroethylene), Kynar (polyvinylidene fluoride), and PFA (perfluoroalkoxy polymer resin); PVC (polyvinyl chloride); neoprene (polychloroprene); silicone elastomers; and Viton® based polymers including copolymers of hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE); and nylon-based polymers (polyamides).

In one embodiment, the lay-up can be wrapped in a first polymeric material 240. The first polymeric material 240 can function as a release layer as well as help consolidate the lay-up when heated. In one aspect, the first polymeric material can be a polyolefin, e.g., polyethylene type polymer. In one embodiment, the second polymeric material 250 can be wrapped around the first polymeric material 240. The second polymeric material 250 can serve to apply additional pressure during the curing process. As such, in one aspect, the second polymeric material 250 can be any type of heat shrink polymeric material including those listed above. In one aspect, the second polymeric material 250 can be a nylon based polymer. In another aspect, the second polymeric material 250 can be a heat shrink polymeric material capable of creating at least 20 psi of pressure when heated. The first and/or second polymeric material 240/250 can be applied or wrapped in multiple layers or a single layer. In some exemplary embodiments, between 1 and 8 layers of polymeric material can be applied. Additional layers allows a greater amount of control of the resulting applied pressure during the consolidation process. In addition, the polymeric material(s) can be wrapped under tension to ensure more even and consistent pressure distribution about the semi-rigid mold.

As described above, the system 210 can further comprise a first polymeric material 240 that may be disposed between the second polymeric material and the semi-rigid mold and fiber material lay-up to facilitate easy removal of the second polymeric material 250 from the semi-rigid mold and/or the formed composite lattice support structure. The first polymeric material 240 may comprise polymeric materials that facilitate release of the consolidated lay-up from the second polymeric material 250 including those listed above, or others. Depending upon various factors, such as the type of second polymeric material used, a first polymeric material may or may not be needed.

The system 210 further comprises a curing system 260 operable to consolidate and cure the fiber materials and resin to form the cross supports and nodes (and collars if made of the layered filaments as described herein) of the lattice support structure. The curing system 260 is generally designed to subject the fiber material lay-up to elevated temperature for a given duration of time to activate the polymeric material (cause negative thermal expansion) and to cause thermal expansion of the semi-rigid mold; although a curing system that subjects the lay-up to elevated pressure may also be used as needed. As such, the curing system 260 may comprise an oven, an autoclave or other suitable device capable of applying the necessary heat and/or pressure to the lay-up.

To effectuate curing, the lay-up (the semi-rigid mold, the fiber/resin deposit and the polymeric material) are subjected to elevated temperatures. In one exemplary embodiment, the elevated temperatures can range from 250 degrees F. to 350 degrees F. The period for curing can range from 10 to 240 minutes. In a more specific embodiment, the elevated temperature can range from 300 to 350 degrees. In a more specific embodiment the cure time can range from 10 to 90 minutes. When the lay-up is heated the polymeric material contracts and applies pressure from above. The semi-rigid mold expands up to 1/16th inch when it reaches 300 degrees F. so that the fiber/resin is compressed uniformly from all sides during the heating/curing process. The shape of the resulting lattice support structure is substantially defined by the groove geometry and the polymeric material. Deformation of the fiber/resin deposit is uniform due to equal forces from the semi-rigid mold and the polymeric material.

FIGS. 16-18 illustrate part of a system for fabricating complex three-dimensional lattice support structures in accordance with one exemplary embodiment of the present invention. In this particular embodiment, the system 310 comprises a semi-rigid mold 314 comprising a plurality of individual segments or modules 317 (see segments 317a and 317b) that can be removably supported to or about a mandrel 316 to make up a complete semi-rigid mold 314 structure or assembly. The individual mold segments 317 can be positioned adjacent one another and secured to the mandrel 316 to function as a single cohesive semi-rigid mold 314 structure. The semi-rigid mold 314 can comprise any number of mold segments 317 to make-up the overall semi-rigid mold 314 structure.

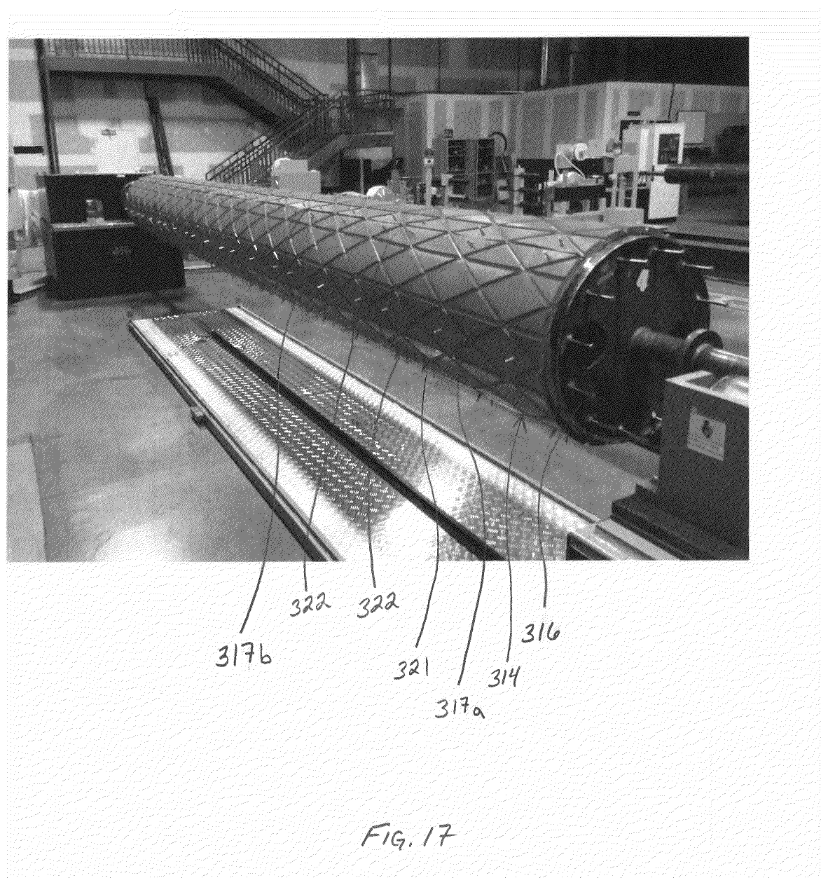

Each individual mold segment 317 can comprise a working surface 318 and a plurality of channels in the form of grooves 322 formed in the working surface 318. When securing the individual mold segments 317 to or about the mandrel 316, the various segments can be positioned such that the grooves 322 formed in the different individual mold segments can be aligned, thus providing a semi-rigid mold 314 having continuous channels as if the semi-rigid mold were one piece (e.g., see alignment of the grooves 322 from each of the adjacent mold sections 317a and 317b of FIG. 17).

The individual mold segments 317 can be secured to the mandrel using various attachment means or fasteners. In the embodiment shown, the individual mold segments 317 are removably secured to the mandrel 316 using a series of pins 321 (e.g., Cleco pins). To facilitate attachment, a series of apertures 319 are formed in the mold segments 317 through which the pins 321, as secured to the mandrel 316, are caused to pass as the mold segments are positioned about the mandrel 316. Once the mold segments 317 are positioned and in place about the mandrel 316 the pins 321 function to secure the mold segments 317 to the mandrel 316, wherein the semi-rigid mold 314 is readied to receive the fiber material 304 into the grooves 322. As described above, a release layer 315 may be positioned between the upper surface of the mandrel 316 and the lower surfaces of the individual mold segments 317 making up the semi-rigid mold 314. The release layer 315 can facilitate extraction of the mandrel from the semi-rigid mold 314 and the formed lattice support structure upon being cured in a curing system (not shown, but part of the system 310 similar to the system 210 described above).

Although the semi-rigid mold 314 comprises a plurality of individual mold segments 317, those skilled in the art will recognize that the semi-rigid mold 314 can be formed from a single piece of material.

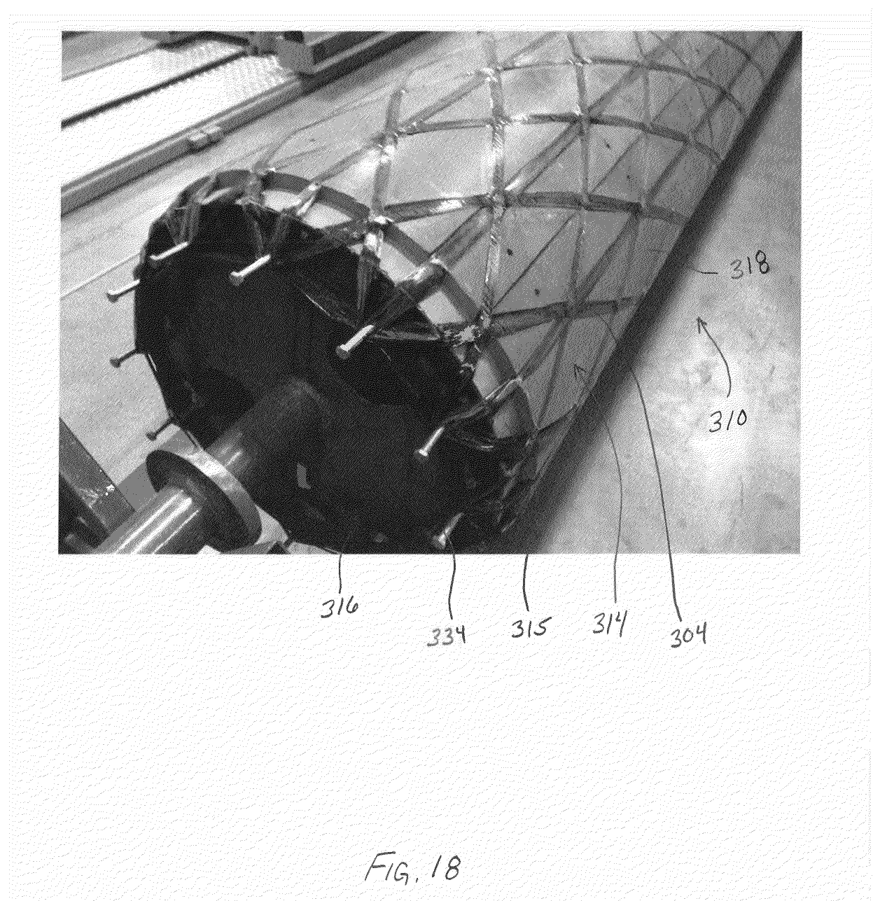

FIG. 18 further illustrates the mandrel 316 as comprising a plurality of pins 334 arranged about an end of the mandrel 316. The pins 334 function to provide support for the fiber material 304 as it is wound onto the semi-rigid mold 314. The pins 334 allow the fiber material 304 to be wound to extend beyond the semi-rigid mold and to facilitate a change in direction of the fiber material 304. Furthermore, the pins 334 are strategically located so that the continuous unidirectional lay-up of fiber material 304 within the grooves of the semi-rigid mold is maintained. The pins 334 further function to maintain the appropriate tension within the fiber material 304 as it is wound onto the semi-rigid mold 314. In the embodiment shown, the pins 334 are positioned at the intersection of the fiber material 304 making up the longitudinal and helical members.

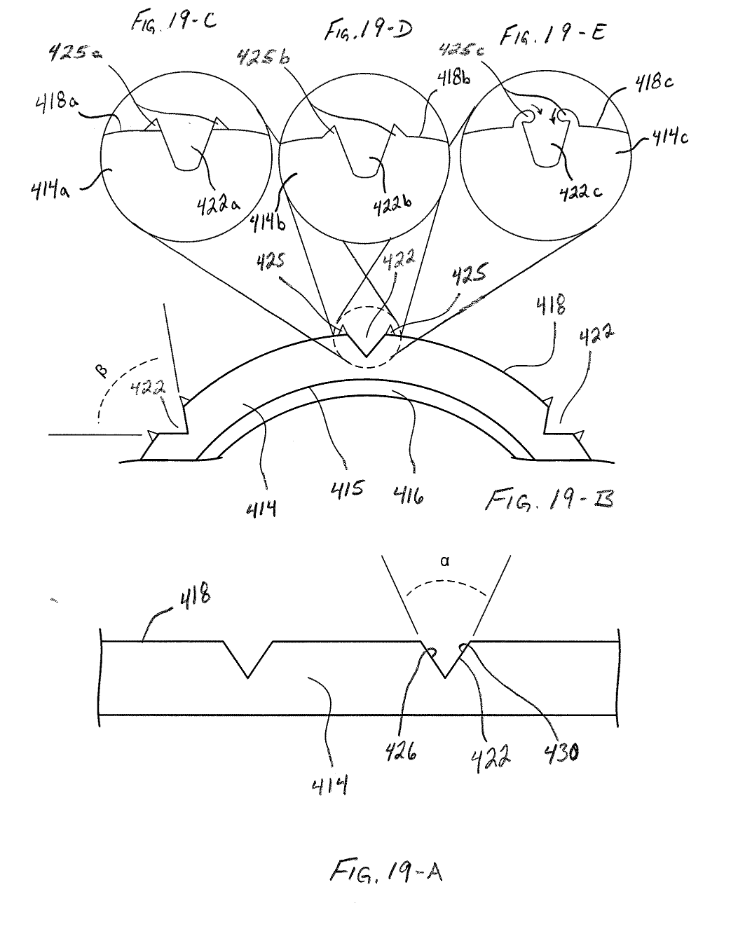

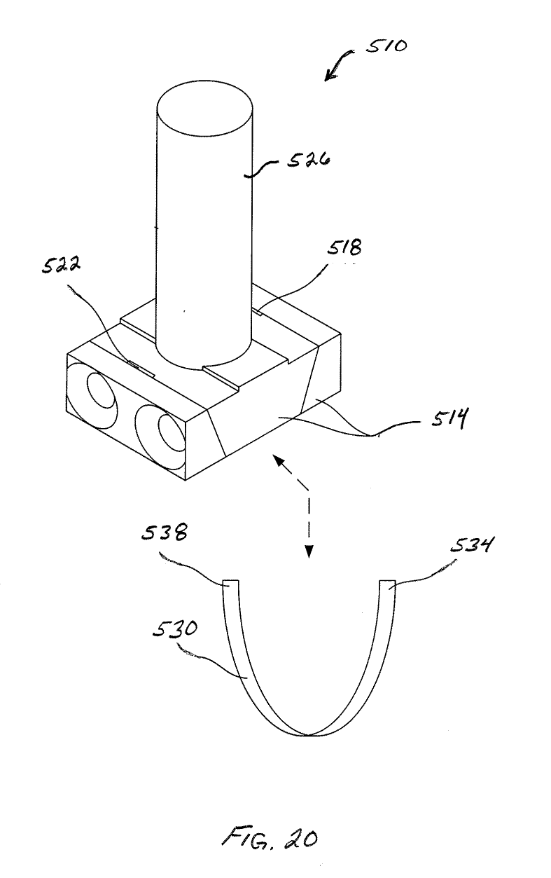

FIG. 19-A illustrates a partial cross-section of a semi-rigid mold 414 in accordance with another embodiment, the semi-rigid mold being in a flattened state or condition. As discussed herein, the semi-rigid mold 414 can comprise one or more grooves 422 formed therein, which grooves 422 can comprise various configurations and geometries. In the embodiment shown, the grooves 422 comprise a v-shaped cross-section having a depth extending below a working surface 418, and walls 426 and 430. The grooves 422 can be formed having a given width at the opening, and sidewalls 426 and 430 having a given angle alpha (α) between them. Due to the pliability of the semi-rigid mold 414, as the semi-rigid mold 414 is secured to a mandrel, the configuration and/or geometry of the grooves may change depending upon the shape and configuration of the mandrel. For example, with reference to FIGS. 19-A and 19-B, a cylindrical mandrel 416 is shown having an outer surface with a given radius of curvature. With the semi-rigid mold 414 secured to or about the mandrel 416, the semi-rigid mold 414 is caused to conform to the curved surface of the mandrel 416, thus increasing the width of the opening, and changing the angle of the v-shaped grooves 422 from their original angle alpha (α) to an angle beta (β), which is typically larger than the angle alpha (α), and which is the end or final desired groove angle for forming the cross supports and nodes of the lattice support structure. In other words, the groove effectively opens up to the final desired configuration and geometry once applied to the mandrel 416. As such, when initially forming the grooves in the semi-rigid mold in its flattened state it may be that the grooves are formed with a certain configuration different from that desired, but which will ultimately end up being the desired groove configuration once the semi-rigid mold is applied to the mandrel to control the desired size and geometry of the cross supports of the lattice support structure to be formed therein. Of course, if the configuration of the mandrel being used is known, the semi-rigid mold may be manipulated into a corresponding position and the grooves subsequently initially formed therein to avoid the issue of changing groove geometries and/or configurations.

As indicated, grooves may be formed in the semi-rigid mold by a material reduction process, such as cutting. FIG. 20 illustrates a cutting tool in accordance with one exemplary embodiment for cutting grooves in a semi-rigid mold. The cutting tool 510 can comprise a base 514 having a first opening 518 and a second opening 522 extending through the base 514. The cutting tool can further comprise a post 526 extending from the base 514 configured to facilitate mounting of the cutting tool 510 to a sliding mechanism (not shown) for effectuating translational movement of the cutting tool 510 about the semi-rigid mold to form the grooves therein. The cutting tool 510 can further comprise a blade 530 configured to perform the cutting function. In one exemplary embodiment, the blade 530 can comprise a thin, elongate configuration designed to be bent upon being installed into the base 514. The blade 530 can comprise a first portion 534 configured to be inserted into the first opening 518 of the base 514 and secured therein, and a second portion 538 configured to be inserted into the second opening 522 and secured therein, wherein the blade 530 is securely coupled to the base 514. As shown, the installed blade 530 extends away from the base 514 to provide an exposed cutting surface and desired geometry.

The geometry of the blade 530 as installed on the base 514 generally dictates and corresponds to the geometry of the grooves in the semi-rigid mold being formed by the cutting tool 510. Those skilled in the art will appreciate that a variety of blade configurations and geometries are possible. As such, those shown in the drawings and discussed herein are not intended to be limiting in any way. In one embodiment, for example to form a semi-rigid mold configured to produce a twenty-four inch diameter lattice support structure, the geometry of the installed blade can comprise a V-shape having a rounded bottom with a radius between 0.05 and 0.25 inches, as well as an angle between the first sidewall and the second sidewall ranging from 30 and 120 degrees. In a more specific embodiment, the angle can range between 30 and 80 degrees. In a still more specific embodiment, the angle can range between 60 and 90 degrees. Such geometries are not intended to be limiting. For example, it is contemplated that grooves can be formed having parallel sidewalls and a flat bottom (with or without rounded corners). In another embodiment, the geometry of the installed blade can comprise and correspond to a V-shape groove (without a rounded bottom). Still further, the installed blade can comprise a geometry such that an extension member in the form of an overhang is created in the semi-rigid mold at the top of the groove. Extension members are discussed in more detail below. Various other installed blade geometries are contemplated herein. It should further be noted that an installed blade will comprise an area that corresponds to an area of the grooves formed by the blade and the cutting tool.

In one example, and with respect to a lattice support structure to be formed having a twenty-four inch diameter, the blade geometry and area can be configured to yield a groove approximately ninety percent (90%) of the desired groove area on a flattened semi-rigid mold. Once the semi-rigid mold is laid over the mandrel, the grooves will open up as described. Specifically, any longitudinal grooves will open up to one hundred and fifteen percent (115%) of the blade area, and helical grooves will open up to one hundred percent (100%) of the blade area. Of course, these numbers will vary with different sized mandrels, and as a ratio of mandrel size to groove size. With this general guideline, a blade having a cross-sectional area matching the desired cross-sectional area of a desired helical groove, any longitudinal grooves will have additional room in the event extra fiber material (and resin) is desired to be added. Indeed, in many cases, longitudinal members comprise additional fiber material (and resin) to enhance strength and other performance properties of these.

The cutting tool 510 can be generally adapted to operate or function with cutting systems that cause translational movement of the cutting tool, thus allowing the cutting tool to traverse and cut into a semi-rigid mold to form the grooves. In one embodiment, the translation movement can be in a single direction. In another embodiment, the translation movement can be in at least two directions. In one aspect, the cutting tool is configured for use with a computer numerical control (CNC) machine.

Generally, the blade 530 of the cutting tool 510 can comprise any material capable of cutting through a semi-rigid mold. In one embodiment, the blade comprises steel and has a cutting depth ranging from 0.125 inches to 1 inch and a width of 0.3 inches to 1 inch. However, these are not to be limiting in any way as those skilled in the art will recognize that other cutting depths are possible, depending upon the size and geometry of the lattice support structure to be formed and the size and geometry of the groove.

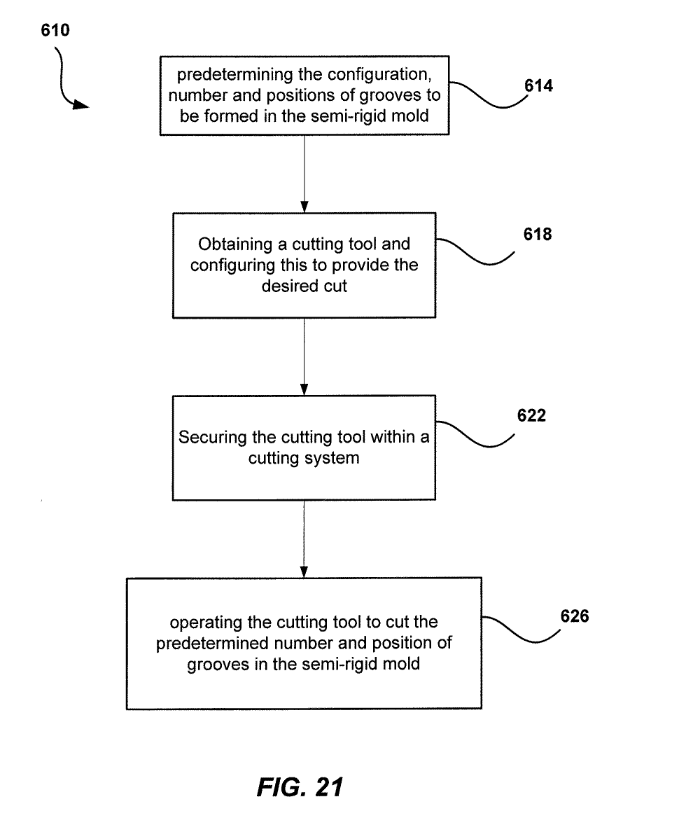

FIG. 21 illustrates an exemplary method for cutting grooves in a semi-rigid mold. The method 610 can comprise predetermining 614 groove configuration, number and positions to be formed on the semi-rigid mold. In one aspect, groove area can be determined based on the amount of fiber material desired to be deposited therein, in addition to any desired overlap (i.e., an amount of fiber material protruding from the groove following curing). The method 610 can further comprise obtaining 618 a cutting tool and configuring this to provide the desired cuts for the grooves. This may include obtaining a blade and configuring this to comprise a certain size and geometry. The method can further comprise securing 622 the cutting tool within a cutting system, such as a manually operated cutting system or a CNC (or other similar type) cutting system. The method can further comprise operating 626 the cutting tool to cut the predetermined number and position of grooves in the semi-rigid mold. The step of operating may be performed manually without any assistance from a computer, or with a CNC machine, wherein the cutting tool is operated by the CNC machine, and the desired cutting parameters are programmed into the computer of the CNC machine. Additionally, the method can further comprise removing the excess cut material from the semi-rigid mold.

Cutting grooves of a specific size and geometry in a semi-rigid mold has various advantages over a semi-rigid mold simply having groove contours (those formed by pressing or casting the mold into a rigid mold, or by laying up the fiber material on the working surface and causing these to deform the mold). One particular advantage is a more evenly applied pressure about the grooves on the fiber material. With groove contours, the semi-rigid mold is already pre-stressed in certain areas at the grooves, which can lead to uneven thermal expansion of the semi-rigid mold about the fiber materials, thus resulting in inferior consolidation of the fiber materials. While a semi-rigid mold having groove contours is contemplated for use herein, it has been found that a semi-rigid mold having specific and precise amounts of material removed to form dedicated and specifically cut grooves results in higher consolidation quality and better performing lattice support structures. Another advantage of cutting grooves is the time to form a desired configured semi-rigid mold. This can be done quickly and inexpensively. Moreover, semi-rigid molds can be changed and/or repaired easily and inexpensively by way of the cutting process.

With respect to the formed grooves in the semi-rigid mold, it has been discovered that grooves having some radius at the bottom (e.g., a v-shaped groove with a rounded bottom) can provide various advantages over grooves having no radius in the bottom (e.g., sharp v-shaped grooves). Indeed, grooves having a radius tend to facilitate release of the semi-rigid mold from the cured lattice support structure more easily. Moreover, these accept fiber material deposition more easily, particularly as the fiber material begins to build up in the grooves. These further eliminate possible tear points from the semi-rigid mold, improving the life of the mold. These still further decrease the chance of cured resin mechanically grabbing the semi-rigid mold, thus easing extraction of the formed lattice support structure.

Although much of the above discussion has centered around v-shaped grooves (with or without a rounded bottom), the specific configuration of the semi-rigid mold and the grooves formed therein may vary from support structure to support structure depending upon various factors, such as ease of manufacturing, desired performance characteristics of the finished lattice support structure, etc. Indeed, many different groove configurations are possible to achieve efficient manufacturing and/or cross supports and nodes having specific performance properties. It has been discovered that some manufacturing processes are more efficiently carried out when using specific groove configurations, and that some lattice support structures perform better than others depending upon the configurations of the cross supports and nodes making up the lattice support structures, as formed by the semi-rigid mold and the corresponding grooves formed therein. Furthermore, the depth of the grooves, and the ratio of groove depth to overall thickness of the semi-rigid mold may vary to change the performance properties of formed lattice support structures. For instance, it has been discovered that for high performance twenty-four inch diameter cylindrical lattice support structures, the semi-rigid mold can comprise a thickness of ¾ of an inch, with the depth of the grooves being ⅜ of an inch, the width of the grooves (at the working surface of the mold) being ⅝ of an inch, and the angle alpha (α) between groove sidewalls being 76.6 degrees. In another example, for high performance six inch diameter cylindrical lattice support structures, the semi-rigid mold can comprise a thickness of ¼ of an inch, with the depth of the grooves being ⅛ of an inch.

It is noted herein that no matter the groove size or geometry, in some embodiments a sufficient amount of material can be caused to remain beneath the grooves to contain the fiber materials and to prevent tearing of the semi-rigid mold.

Referring back to FIG. 19-B, as well as FIGS. 19-C-19-E, the semi-rigid mold 414 may further comprise one or more extension members 425 extending above the working surface 418 of the semi-rigid mold 414, and located generally adjacent the opening of the grooves 422 (see extension member 425 of FIG. 19-B, extension members 425a of FIG. 19-C, extension members 425b of FIG. 19-D, and extension members 425c of FIG. 19-E). Extension members 425 can comprise a height extending above the working surface 418 of the mold 414 sufficient to allow them to function to contain or retain excess fiber material (and resin (not shown)) within the grooves 422, the extension members effectively being an extension of the grooves 422 above the working surface 418. Employing extension members 425 can help to maintain fiber material off of the working surface during the wrapping and consolidation stages of manufacture.

The extension members 425 can extend above the working surface 418 of the mold 414 from 1/16^{th} of an inch to 1 inch, and can comprise a number of different cross-sectional sizes and geometries depending upon the size of the lattice support structure being formed, the size of the grooves, the amount of fiber material to be deposited, etc.

FIG. 19-C illustrates extension members 425a comprising structures separate from the semi-rigid mold 414a, these having a triangular cross-sectional shape. In this embodiment, the extension member 425a are added or joined to the working surface 418a of the semi-rigid mold 414a at a position adjacent the opening of the groove 422a. While the extension members will likely be formed from the same material as the semi-rigid mold, it is contemplated that the extension members may comprise a different material. Joining of extension members to the semi-rigid mold that are separate from the semi-rigid mold, or that are not integrally formed with the semi-rigid mold, may include mechanically coupling these, bonding these, and others.

FIG. 19-D illustrates extension members 425b that are integrally formed with the semi-rigid mold 414b. In this embodiment, the extension members 425b comprise a triangular cross-sectional shape, and can be formed by removing material from the working surface 418b adjacent groove 422b sufficient to provide a desired height of the extension members 425b. Due to the reduction in material from the semi-rigid mold, forming the extension members in this manner may require starting with a semi-rigid mold having an increased thickness over a semi-rigid mold where no extension members are employed where a similar groove size and configuration is desired.

Depending upon their configuration, the amount of fiber material disposed within the grooves 422, etc., the extension members 425 can further be configured to aid in the compression of the fiber material and resin during the consolidation stage. For example, the extension members 425 can be configured to be dynamically moveable from a first retaining position to a second pressure inducing position, particularly when caused to move by a polymeric wrap about the mold and the lay-up. FIG. 19-E illustrates one exemplary embodiment of extension members 425c capable of performing such a function. In this embodiment, the extension members 425c extend above the working surface 418c of the semi-rigid mold 414c, as well as partially overhang and extend into the groove 422c. Upon depositing the fiber material within the groove 422c, a polymeric wrap can be deposited about the mold 414c and the lay-up as discussed herein. The polymeric wrap can cause the extension members 425c to bend or deflect into the groove and about the fiber material therein. The extension members can be sized so that they contact one another in their deflected position either prior to consolidation, during consolidation or both. During consolidation, and assuming they are comprised of the same material as the semi-rigid mold, the extension members can undergo thermal expansion similar to the semi-rigid mold to effectively provide the same type of pressure and compaction from the top down as is being applied by the mold from the sides of the groove.

As apparent to on skilled in the art, the size and geometries of the extension members shown and described herein are merely exemplary and are not intended to be limiting in any way. Furthermore, those skilled in the art will recognize that the extension members can be formed in a variety of ways, such as those described above, molding the extension members to the semi-rigid mold, and others.

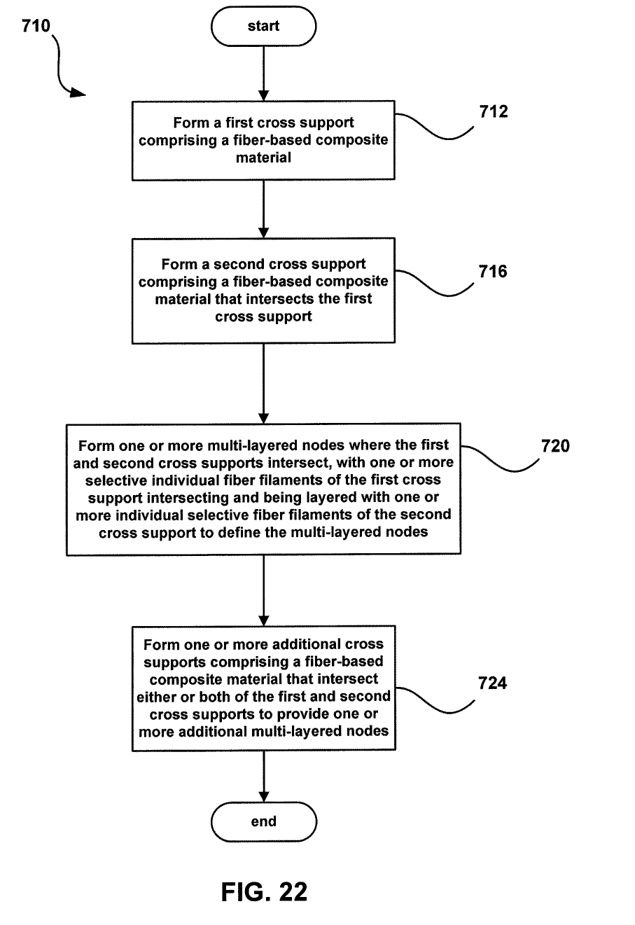

FIG. 22 illustrates a flowchart of a method for forming a composite lattice support structure in accordance with one exemplary embodiment. The method 710 comprises generally forming 712 first and second cross supports, each of these comprising a fiber-based composite material. The first and second cross supports are caused to intersect one another in one or more locations to define and form 720 one or more multi-layered nodes. The multi-layered nodes are each comprised of one or more selective fiber filaments (individual filaments or layers of filaments) from the first cross support that intersect and layer with one or more selective fiber filaments of the second cross support. In one aspect, this may mean that the multi-layered nodes comprise at least two layers of the first cross support separated by at least one layer of the second cross support. In another aspect, this may mean that the multi-layered nodes comprise at least two layers of the second cross support separated by at least one layer of the first cross support.

The method further comprises forming 716 one or more additional cross supports, also comprising a fiber-based composite material, that intersect one or both of the first and second cross supports to provide or define or form 724 additional multi-layered nodes within the lattice support structure. Indeed, it is likely that a present invention lattice support structure will comprise a plurality of cross supports, each contributing to the overall strength and performance of the support structure. The plurality of cross supports, comprising a fiber-based composite material, may each be configured to interrelate with at least one other cross support in the same manner, namely with selective fiber filaments from each being layered with those of another cross support at the intersecting locations where a node is formed.

The several cross supports are configured to form and define a composite lattice support structure having a three-dimensional geometry about a centerline. As a result of the fabrication method, the lattice support structure is capable of being a seamless structure rather than the result of two or more segments or components formed separately and then somehow fused or otherwise brought and held together. However, it should be noted that two or more formed lattice support structures may be coupled or otherwise joined together to form a tower or other structure made up of a plurality of individual lattice support structures. For example, a communications tower may be formed of a plurality of lattice support structures joined end to end along a common centerline or axis up to a given length or height. This is discussed further below.

The first and second cross supports and any additional cross supports may be formed into a number of configurations or in accordance with a number of designs to provide different lattice support structures having different performance characteristics. The method for manufacturing described herein allows for a significant amount of versatility in terms of design considerations and options for complex three-dimensional lattice support structures, which is evidenced by the many different configurations described or contemplated herein, some of which are illustrated in the accompanying drawings. For example, the method may comprise forming one or more cross supports to comprise a curved segment between nodes to provide non-linear path loading along the cross support. Depending upon the cross-sectional area of the lattice support structure, curved segments may be present in a plurality of forward or reverse helically oriented cross supports. These helicals may be evenly or unevenly spaced apart from one another (asymmetric spacing), some may have a different pitch than others, some may have a variable pitch or helix angle, and/or they may be present in differing densities about the structure. The support structure may also be formed with a different number or uneven ratio of forward and reverse helicals, thus giving the support structure increased strength in a given direction or in a given location.

In another example, the support structure may comprise any number of lateral, linear or circumferentially oriented cross supports in combination with the helical or reverse helical cross supports, with these also being present in various size, in various locations, in various concentrations, in various densities, etc. Although the majority of time this will most likely be the case, it is also noted that the cross supports and the nodes they define do not necessarily need to comprise any particular type of pattern or symmetry. Indeed, lattice configurations where nodes are completely randomly located or that are present in higher or reduced concentrations or densities about the support structure are also entirely possible and contemplated.

In many cases, it will be necessary or desirable to form the lattice support structure to comprise areas of selective reinforcement or areas of higher strength. In such cases, forming the lattice support structure to comprise cross supports that are grouped or concentrated in these areas, or that are of differing type and/or orientation (or a combination of these) will enhance the inherent performance characteristics of the lattice support structure in these areas, thus being capable of better meeting often stringent engineering specifications.

One of the advantageous properties of some embodiments of the present invention composite lattice support structure is that it can comprise a constant load path throughout. A related advantage is that, in the event of breakage or failure of one or more cross supports or nodes, the lattice support structure is configured such that the load path is transferred to one or more unbroken cross supports to compensate for the reduction in performance or failure of a certain cross support or node.

The method further comprises forming the cross supports such that the resulting lattice support structure comprises a non-uniform cross section as taken along the longitudinal axis or centerline. Lattice support structures with a uniform cross section are obviously contemplated, but some applications may require those having non-uniform cross-sections.

The method further comprises controlling the cross-sectional geometry of some or all of the individual cross supports within a lattice support structure, which cross-sectional geometry of the cross supports is dictated by the corresponding cross-sectional geometry of the channels of the semi-rigid mold in which the fiber material is initially deposited. Controlling the cross-sectional geometry of the cross supports means controlling the elements and parameters used to fabricate these. For example, to achieve a t-shaped or flanged geometry, the channels of the semi-rigid mold will be configured with a suitable t-shaped or flanged configuration. These will have a suitable and accurate amount of fiber material deposited in them in order to achieve the desired geometry after consolidation.

The method can further comprise forming a circumferential collar around or about one or both ends of the lattice support structure, wherein the collar can comprise fiber material that is integrally formed and consolidated with the fiber material of one or more cross supports.

The present invention provides a unique method for fabricating or manufacturing the composite three-dimensional lattice support structures discussed above. In one exemplary embodiment, the method comprises wrapping pre-impregnated fiber filaments or tow (e.g., 12K tow) (or dry fibers wetted during the winding process) around a semi-rigid mold having a series of grooves or channels formed into the surface of the mold generally conforming to the desired configurations or patterns of the various cross members, end collars, multi-layered nodes, etc. to be formed, and providing a solid geometric base for the formation of the support structure during production, which can be supported by a rigid mandrel. A secondary wrap, e.g., KEVLAR, may be applied once the structure has been cured or combined with the primary fibers before cure. It has been found that enhanced consolidation of members can be achieved through covering the uncured structure with one or more layers of polymeric material that functions to undergo negative thermal expansion (i.e., shrink or constrict) when subjected to heat, thus creating pressure over or about the semi-rigid mold and the fiber material within the channels or grooves. In addition, thermal expansion of the semi-rigid mold against the polymeric material is achieved. Indeed, subjecting the polymeric material, semi-rigid mold and composite lay-up to a curing cycle (e.g. a curing cycle within an oven where resulting pressure occurs) functions to compact the fiber material into the grooves, thus consolidating these, and forming the resulting structural members generally to the cross-sectional geometry of that of the grooves. Forming the lattice support structure in this manner adds strength through allowing segments of components to be formed from a continuous filament, while also allowing the various strands in a single member to be consolidated during curing. Other embodiments and additional detail regarding the fabrication of the present invention lattice support structures are provided below.

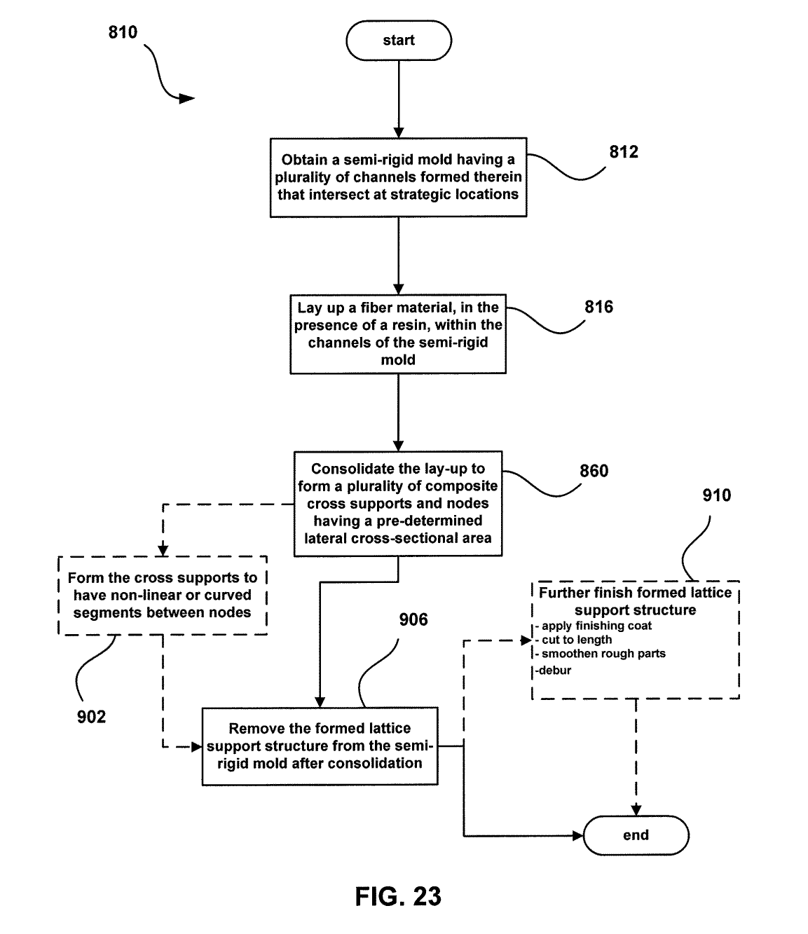

With reference to FIGS. 23-25, one exemplary method of manufacture comprises obtaining a semi-rigid mold having a plurality of channels or grooves formed therein that intersect at strategic locations 812; laying up a fiber material, in the presence of resin, within the channels of the semi-rigid mold 816; consolidating the lay-up to form a plurality of composite cross supports and nodes having a pre-determined lateral cross-sectional geometry, and to form a three-dimensional lattice support structure 860; removing the formed lattice support structure from the semi-rigid mold (506); and optionally, further finishing the formed lattice support structure 910. The method may further comprise forming the cross supports to comprise a non-linear or curved configuration between nodes 902.

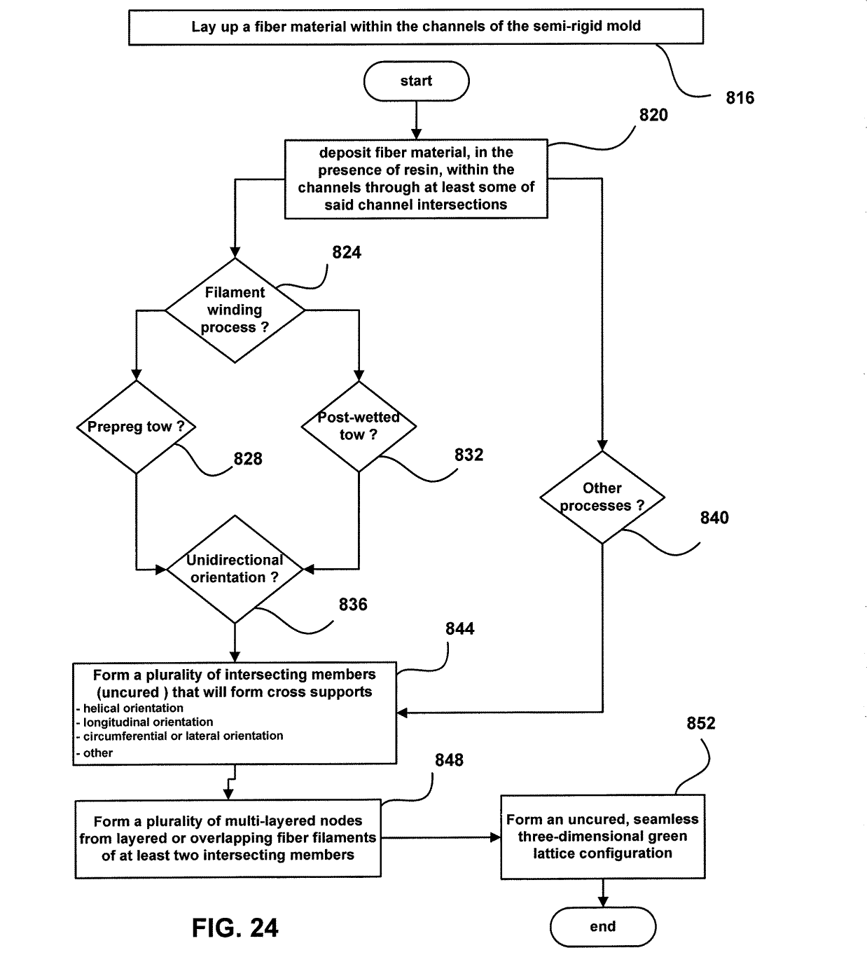

With specific reference to FIG. 24, laying up the fiber material within the channels of a semi-rigid mold 816 contributes to the versatility and ease of manufacture of the lattice support structure. This starts with depositing a fiber material, in the presence of resin, within the channels with the fiber materials extending through the intersections formed in the semi-rigid mold 820. Although other fiber deposition methods may be employed 840, this will typically involve a filament winding process 824 using a prepreg tow or towpreg 828 or a post-wetted tow 832 dispensed from a spool at a given tension and speed. Depositing filaments within the channels under a relatively high tension generally results in a final product with higher rigidity and strength, while filaments deposited using a lower tension generally results in more flexibility. As such, it is contemplated that the amount of tension used to form different support structures may vary depending upon the desired performance properties to be achieved.

In addition, in one aspect, the fiber material may be laid up to extend in a unidirectional orientation within the channels and through the nodes 836 so that any directional changes at the nodes are eliminated. Unidirectional orientation of the fiber material or fiber filaments for each of the members (e.g., formed cross supports and nodes) contributes to more efficient layering of the fibers, and to enhanced overall strength of the lattice structure once formed. This is unlike prior lattice structures that are comprised of multi-directional materials (e.g., woven, thin-walled tube, etc.), as well as products such as cast or wood products.

In another aspect, directional changes of the fiber material at the nodes may be made if desired. However, it is noted that even with directional changes at the nodes, the unidirectional orientation of the fiber materials or filaments within any given channel may be maintained.

Depositing fiber material within the channels in the presence of a resin leads to the formation of a plurality of green, uncured members that intersect and that will ultimately become the various types of rigid cross supports 844 and resulting multi-layered nodes 848 (the multi-layered nodes being formed from layered or overlapping fiber filaments of at least two intersecting members) that make up the lattice support structure. Although these are in a green, uncured or unconsolidated state upon the completion of the filament winding phase, the result is a green, uncured, three-dimensional lattice preform configuration already having a seamless formation 852 prior to undergoing any curing or consolidation processes.

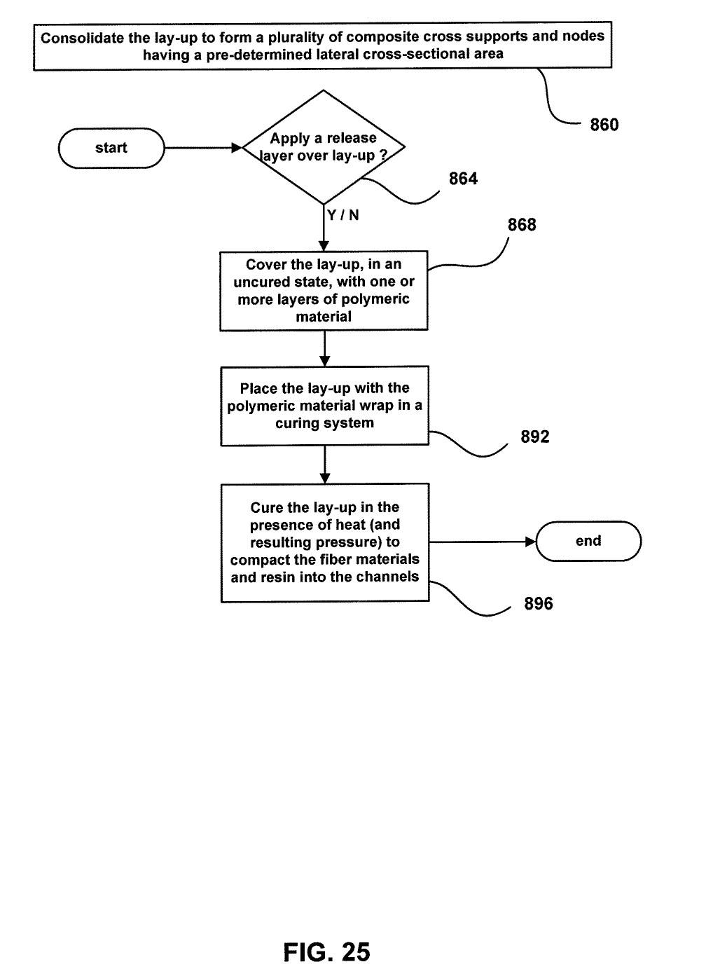

With specific reference to FIG. 25, in one exemplary embodiment, consolidating the uncured fiber material lay-up just described to form the cross supports and nodes 860 comprises covering the semi-rigid mold and fiber material lay-up with a polymeric material 868. Optionally, a release layer may be situated or applied 864 between the fiber material lay-up and the polymeric material in order to facilitate easier release of the polymeric material from the formed lattice structure. Depending upon the type of polymeric material used, a separate release layer may or may not be necessary.

Consolidating further comprises placing the lay-up within a curing system 892 and curing the lay-up in the presence of a heat (and resulting pressure) to compact the fiber material into the channels 896 of the semi-rigid mold. The resulting pressure is generally created by thermal expansion of the semi-rigid mold against the polymeric material or wrap and the fiber lay-up, and the contraction or shrinking of the polymeric material or wrap against the semi-rigid mold and the fiber lay-up. As this pressure is applied, the fiber materials begin to compact into or within the channels. Simultaneously, the channel surfaces apply an additional force on the fiber materials (based on the thermal expansion of the semi-rigid mold), constraining the movement or displacement of the fibers as well as pressurizing them. As heat and pressure is applied for a given duration, the fiber materials consolidate with the resin, and are caused to substantially assume the geometry of the channels, bounded also by the polymeric wrap. Consolidation may continue as long as needed to eliminate or minimize any remaining voids.

Being able to manipulate the cross-sectional geometry of the cross sectional shape of the individual cross supports is a significant advantage of the present invention lattice support structure manufacturing method. As discussed above, this provides the ability to control or manipulate the moment of inertia of the cross support members.

It has been recognized that the closer the fibers are held together, the more they act in unison as a single piece rather than a group of fibers. In composites, resin can facilitate holding the fibers in close proximity to each other both in the segments of the cross supports themselves, and at the multi-layered nodes when more than one directional path is being taken by groups of unidirectional layered fibers. In filament winding systems of the present disclosure, composite tow or roving or tape (or other shaped filaments) can be wound and shaped into the channels of a semi-rigid mold, and then the composite fibers forced together using pressure. Under this pressure, heat can also be used to fuse the multi-layered nodes, generating a tightly consolidated multi-layered node. Thus, the multi-layered node is constrained within the channels or otherwise held in place tightly using pressure from both the polymeric wrap and the surfaces of the channels. Under such omni-directional pressure from all sides, the multi-layered node (including the filament or tow material and the resin) can be heat fused or cured, making the multi-layered node more highly compacted and consolidated than other systems in the prior art. As a result, high levels of consolidation can be achieved. In other words, voids and weak spots in the formed lattice structure are significantly reduced or even virtually eliminated. In one embodiment, the void content can be less than 4%. In another embodiment, the void content can be less than 2%. In still another embodiment, the void content can be 0% to 0.5%. In short, consolidation control using a semi-rigid mold and a polymeric material to induce or apply pressure about the semi-rigid mold and over the wound filament or fibers, and resin/heat curing provides high levels of consolidation that provide enhanced strength to the lattice structure as a whole.

Referring again to FIG. 23, the method may further comprise removing the polymeric wrap and separating the composite lattice support structure from the semi-rigid mold 906. This may include removing the cured lattice structure from the mandrel that supports the semi-rigid mold.

The method may still further comprise further finishing the formed lattice support structure 910, which may include trimming edges or ends, deburring, sanding where necessary, etc. This may also include coating the surfaces of the support structure with a finishing coat. For example, in one aspect, this may comprise spraying the surfaces with a resilient polymer (e.g., two part prepolymer or polyurethane such as VacuSpray®), or another similar type of protective coating.

In keeping with the concept of finishing, this method step may further comprise a finishing process, wherein the formed composite lattice support structure is subjected to a particulate for the purpose of removing unwanted excess material (fiber and/or resin) following the consolidation process. In one exemplary embodiment, the lattice support structure can be at least partially submerged in the particulate and systematically rotated to cause the particulate to contact the various surfaces of the cross supports and nodes, thereby removing the unwanted excess material at the surfaces. This may further include reducing at least of portion of material of the cross supports and/or nodes.

As described herein, the present lattice support structures are manufactured from a composite fiber/resin material and can have excess material along the cross-supports and/or nodes. As such, the deburring process functions to remove such excess material in an efficient manner without requiring manual labor. Notably, the present lattice support structures comprise a plurality of cross supports and nodes, each having multiple surfaces (or surfaces facing in multiple different directions), thus making conventional deburring processes, such wire brushing, vibratory processes, sand blasting processes, etc., inefficient and ineffective. Unlike these conventional deburring processes, the present deburring method (and the corresponding deburring system described below) provides simultaneous material reduction along multiple surfaces of the cross-supports and nodes. Notably, wire brushing processes are generally directed to substantially unidirectional forces and lack the ability to impinge multiple surfaces of the lattice at the same time. Sand blasting processes involve imparting forces to the particulate, also generally in the unidirectional manner. Vibratory processes generally involve imparting vibratory forces to both the particulate and the part. Vibratory processes can be especially problematic for the present lattice support structures since the lattice is generally less dense than the particulate material, which causes the lattice structure to “float.”

While not being bound by any particular theory, it is thought that the present invention finishing (e.g., deburring) process for removing unwanted excess material is effective as the movement of the lattice structure through the particulate provides for simultaneous impingement of multiple surfaces of the lattice structures. The method of rotating the formed lattice support structure in the particulate media causes the particulate to impinge on the edges of the part in a tangential direction. This causes removal of excess composite material precisely where wanted. The present lattice support structures have the added challenge of reducing material without damaging individual cross supports and nodes. The forces of the present invention deburring process can be tailored to specific lattice support structures. Additionally, the present deburring method can provide various forms of material reduction in addition to deburring, such as smoothing, rounding, etc.

Additionally, the present process is generally systematically applied to the lattice support structure providing a uniformity not achieved by manual processes, or specific location/direction processes. While manual deburring processes can be applied to a structure in a systematic fashion, such processes generally do not provide uniformity of pressure, time, force, etc. for each part of the structure, and are extremely labor intensive. For instance, for a similar part, manual deburring can take 20 man hours to perform. The present invention deburring process can be applied across the entire lattice structure quickly and simultaneously thereby providing a uniformity in conditions and processing parameters that is generally not achieved in manual processes. While not required, in one embodiment, the present process can help to provide a more uniform lattice structure. Notably, such uniformity can be achieved by a non-uniform reduction of material. For example, a lattice support structure having excess material along one area can be subjected to a particulate where the particulate causes an increased material reduction for that area as compared to the remaining areas, thereby providing an overall uniform finished lattice support structure.

The particulate material generally comprises material capable of reducing material from a formed lattice support structure. In one embodiment, the particulate material can include abrasive material. In another embodiment the particulate can include non-abrasive materials. In still another embodiment the particulate can include random mixtures of different types of particulates.

With respect to an abrasive type of particulate material, such abrasive materials can include natural or synthetic materials. In one embodiment, the particulate can be an abrasive material selected from the group consisting of gravel, polymeric material, metal, rock, mineral, sand, and mixtures thereof. In addition, the particulate materials can include particulates having uniform or different sizes (either random or selected). The particulate materials can have an average particle size ranging from 0.1 mm to 0.5 inch. In another aspect, the particulate materials can have an average particle size ranging from 0.1 inch to 0.25 inch. Particle size refers to the longest dimension. In one specific embodiment, gravel known in the gravel industry as “gyro” can be used. This particular particulate is inexpensive and effective, and has a particle size ranging from about 0.125 to 0.25 inches.

The lattice support structure can be supported about a support/rotation system, and can be brought into contact with the particulate material under a uniform pressure (i.e., subjected to a uniform pressure) across its rotational axis. The lattice support structure can be rotated in a single direction, or in multiple directions. In many cases, the lattice support structure will be rotated in one direction for a period of time and then rotated in the opposite direction for an additional period of time. As such, the present process can include a systematic process including periodic rotations of the lattice structure within the particulate material.

Control parameters of the present process can be varied to provide or obtain different finishing results. Control parameters can include: pressure on the lattice support structure within the particulate material, rotational speed of the lattice support structure, the depth within the particulate material that the lattice support structure is placed, the size of the particulate material, the type of particulate material, the way the particulate material is contained, etc. These control parameters are generally not found in prior art finishing systems. These parameters can also contribute to determining the uniformity of the finishing step and can be varied in order to alter or affect the type of finishing. For example, rotating the lattice support structure at higher RPMs for a given amount of time can provide a deburring function for further processing, whereas rotating at slower RPMs for longer periods of time can provide more of a smoothing finishing function.

The present invention process can include multiple material reduction stages to achieve different results. For example, in one embodiment, a lattice support structure can first be deburred using a first set of processing parameters and then further smoothened using a second set of processing parameters.

Unlike prior finishing systems where the particulate is caused to move about a stationary structure, in the present invention deburring process it is the lattice support structure that is caused to move in a controlled manner about one or more axes relative to the particulate. As such, the present invention deburring process does not involve manipulating or moving the particulate relative to the support structure, but the support structure relative to the particulate. In prior art systems, kinetic energy is imparted to the particulate prior to it coming in contact with the part to be finished. In the present invention, on the other hand, kinetic energy is imparted to the lattice support structure which is only transferred to the particulate material after being contacted by the lattice support structure. Controlled movement about an axis of the lattice support structure can include rotation, agitation, translation, etc. Generally, the controlled movement is about the rotational axis. In one embodiment, controlled and systematic rotation about the longitudinal axis of the lattice support structure can be achieved. Further, the lattice support structure can be moved in a plurality of revolutions in multiple directions.

Subjecting the lattice support structure to the particulate, and rotating it in multiple directions can cause different leading edges to be subject to the particulate material. As such, the present invention provides a dynamic effect achieved as the particulate is contacted, which allows the various surfaces of the lattice support structure to simultaneously be processed, even those on the interior. As discussed above, systematic rotation can be performed in a first direction for a given period of time, and then in a second direction opposite the first direction for a given period of time. In one embodiment, the period of time of rotation in any direction can be from 5 minutes to 5 hours.

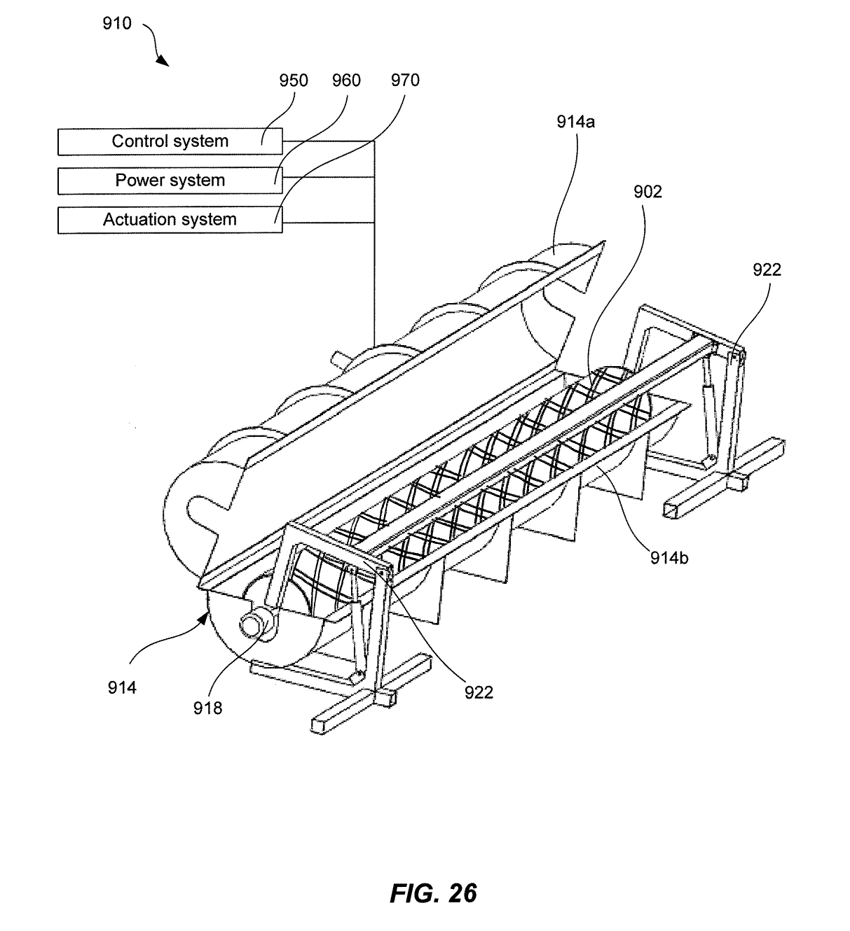

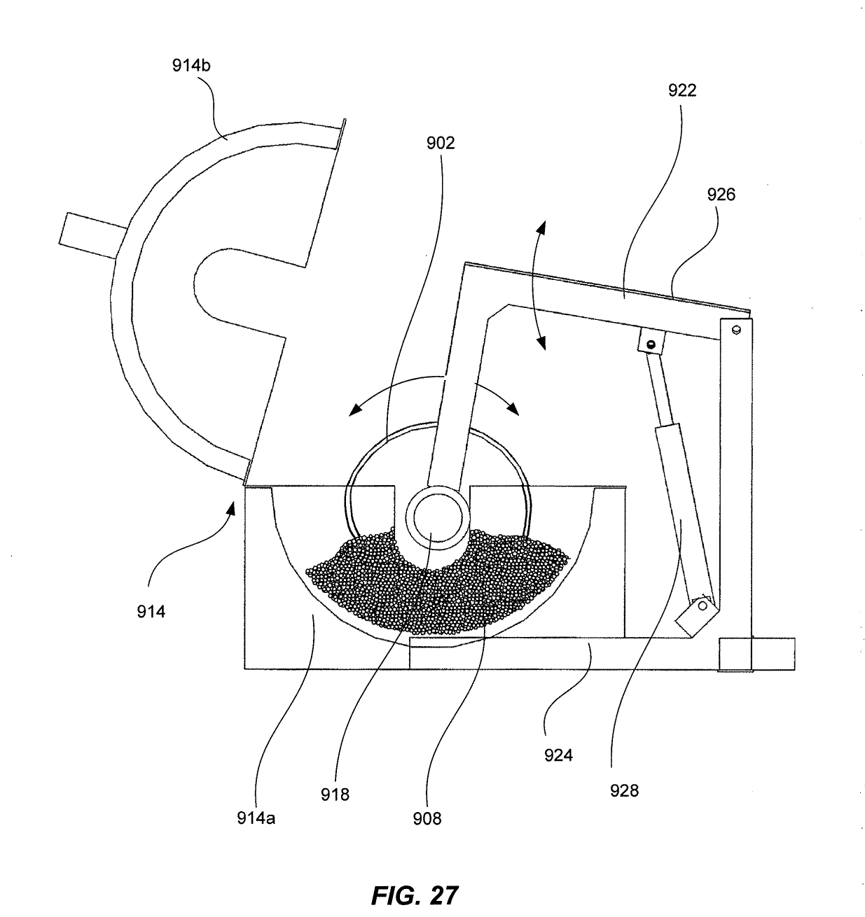

Corresponding to the method and process above, the present invention further comprises a finishing system. With reference to FIGS. 26-28, illustrated is a finishing system 910 for finishing a lattice support structure in accordance with one exemplary embodiment. The finishing system 910 can comprise an enclosure 914 configured to hold a particulate material (shown in FIG. 27) and to receive a lattice support structure therein. The enclosure 914 can be generally cylindrical, and can comprise a first portion 914a in the form of a trough, and a moveable second portion in the form of a cover 914b. The system 910 can further comprise a rotating mechanism 918 for rotating an object 902 (e.g., a lattice support structure) within the enclosure 914. The system 910 can further comprise a lift mechanism 922 for lifting the lattice support structure in and out of the enclosure 914. As shown in FIG. 26, the rotating mechanism 918 can be located about a rotation axis corresponding to a longitudinal center axis of the object 902, in this case the lattice support structure. The system 910 can further include a control system 950 for controlling operation of the finishing system 910 (e.g., computer, processer, control panel, different types of sensors, feedback system, etc.), a power system 960 (e.g., power source, motor, etc.), and an actuation system 970 (e.g., hydraulic actuators and associated incompressible fluid, pump, etc.; pneumatic actuators and associated air and pump; and others).

With specific reference to FIG. 27, the finishing system 910 can include particulate material 908 contained within the enclosure 914. The lattice support structure 902 can rotate within the particulate material 908 in a clockwise and counterclockwise direction via the rotating mechanism 918. The lift mechanism 922 comprises a first stationary frame member 924 and a second moveable frame member 926 that can pivot relative to the first frame member 924, such that the lattice support structure can be moved in and out of the enclosure 914. An actuator 928 can be operable with the first and second frame members 924 and 926 to facilitate movement of the second frame member 926. In one embodiment, the lift mechanism 922 can be mobile, so as to be able to be positioned proximate the enclosure 914 during a finishing process, and then away from the enclosure 914 as needed.

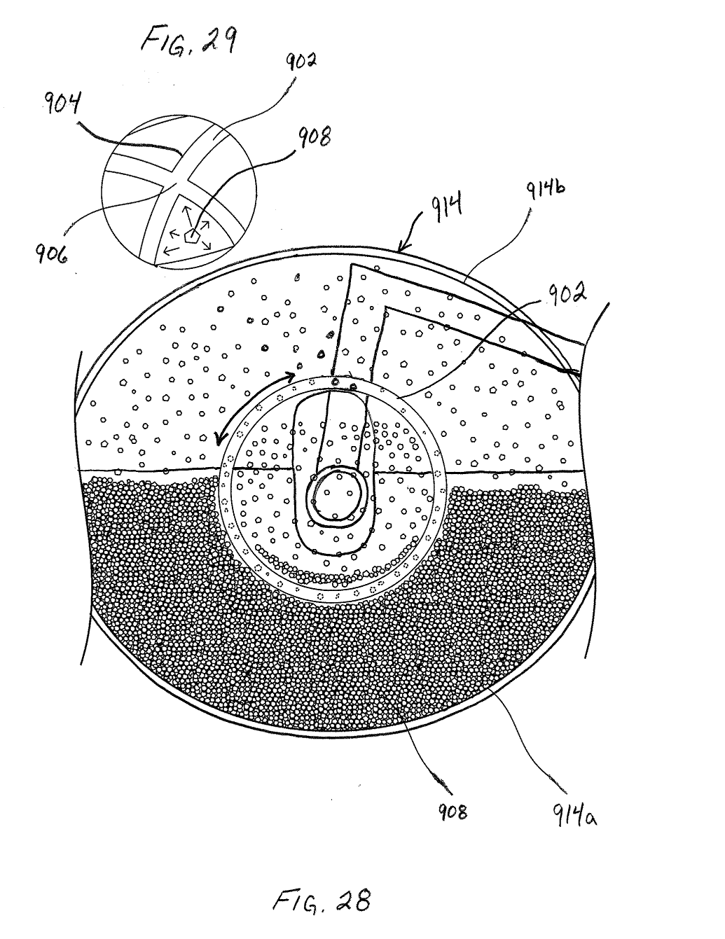

With specific reference to FIG. 28, illustrated is the lattice support structure 902 placed within the enclosure 914 with the cover 914b portion of the enclosure 914 located in a closed position about the trough or bottom portion 914a. As can be seen, the enclosure 914 further has contained therein a particulate material 908. The lattice support structure 902 is positioned such that the particulate material 908 is located about all surfaces of the lattice support structure 902, including both inside, outside, and side surfaces. In one aspect, the lattice support structure can be placed between 10% to 90% below the surface of the particulate. During rotation of the lattice support structure 902, the particulate material 908 is caused to contact all of the surfaces of the lattice support structure, and particularly the cross supports and the nodes.

FIG. 29 illustrates a graphical representation of a particulate matter 908 and how it is caused to contact various surfaces of the cross supports 904 and the nodes 906 of the lattice support structure 902. Those skilled in the art will appreciate that with the lattice support structure subjected to an enclosure full of similar particulates, as shown, and with the lattice support structure caused to rotate in a given manner within the enclosure and in the presence of the several particulates, that the several particulates will impact and finish all surfaces of the lattice support structure.

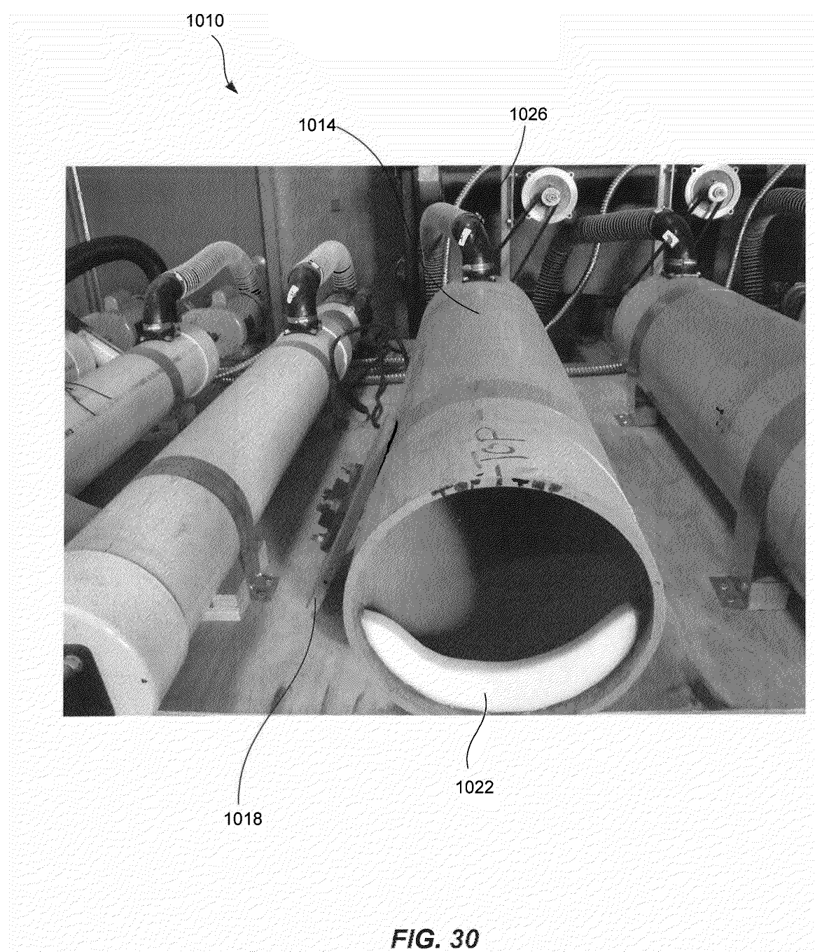

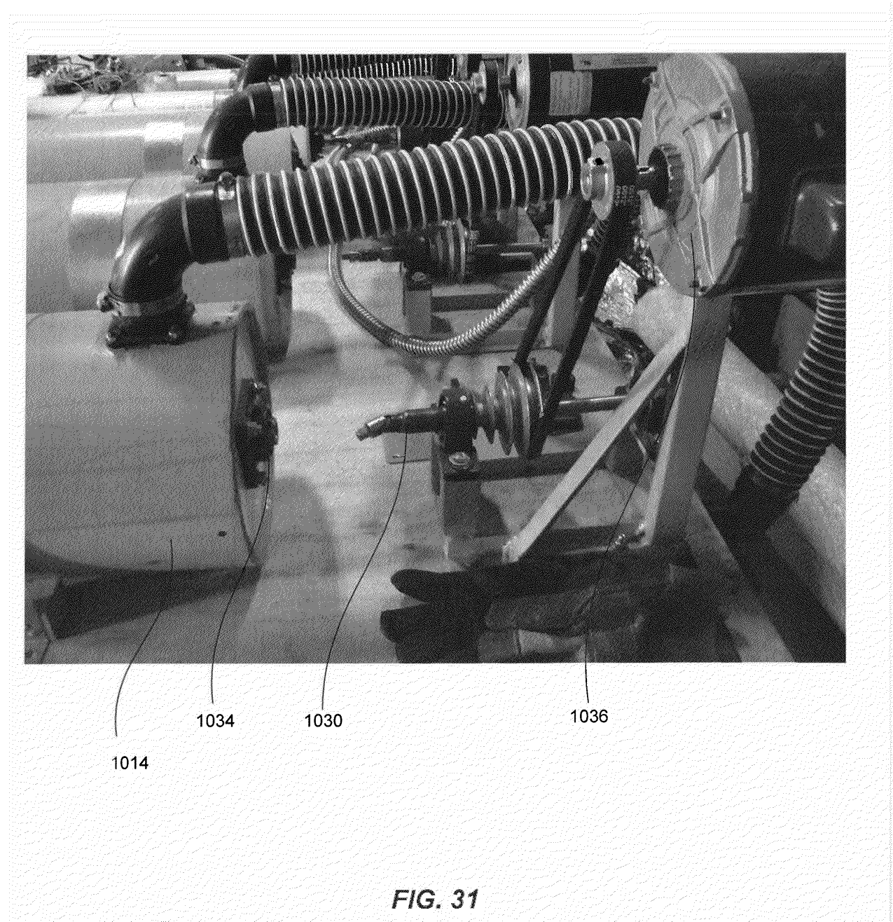

FIGS. 30-31 illustrate an alternative embodiment of a finishing system, wherein the finishing system 1010 comprises an enclosure 1014 in the form of a pipe. The enclosure can include a removable end cap 1018 and a retaining member 1022 for retaining the particulate material within the enclosure 1014 when the end cap 1018 is removed. The finishing system 1010 can function in a similar manner as the finishing system described above upon inserting an object, such as a lattice support structure, into the enclosure 1014. The enclosure 1014 can further comprise a ventilation conduit 1026 that can serve to remove fine dust that is produced during processing.

The finishing system 1010 can further comprise a rotating mechanism 1030 that can include a retaining mechanism 1034 for holding the lattice support structure and a motor 1036 for rotating the lattice support structure. In addition to rotational movement, the rotating mechanism 1030 can be configured to provide translation movement within the enclosure 1014.

In another exemplary embodiment, the finishing system 1010 can include multiple enclosures and multiple rotating mechanisms. With this arrangement, different finishing functions or different finishing types can be separated to provide different finishing results. For instance, a single lattice support structure can go from one enclosure to another to another to obtain progressive finishing, or finishing of different types.

As indicated above, the finishing systems described herein can be employed to carry out one or more finishing processes by placing a lattice support structure in an enclosure, the enclosure containing a particulate; systematically rotating the lattice support structure within the enclosure; and removing the lattice support structure from the enclosure. Generally speaking, the lattice support structure is placed into the particulate, although this is not required. Alternately, the lattice support structure can be placed in the enclosure and the particulate can be placed on/in the lattice structure. Indeed, the process can include depositing particulate into the enclosure and/or the lattice support structure after placement of the lattice support structure. The method can further comprise removing the particulate from the lattice support structure prior to removing the lattice support structure from the enclosure.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention. Also, any steps recited in any method or process claims can be executed in any order and are not limited to the order presented in the claims.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A lattice support structure, comprising a plurality of fiber-based cross supports intersecting one another to form a multi-layered node, the cross supports comprising fibers in a unidirectional orientation so the fiber materials maintain a unidirectional path through the formed multi-layered node, the cross supports being consolidated within a groove of a semi-rigid mold in the presence of resin, heat, and pressure.

2. The lattice support structure of claim 1, wherein the multi-layered node comprises bulging along the sides and top, and a spread configuration.

3. The lattice support structure of claim 1, wherein the semi-rigid mold has a Shore A hardness of between 40 A to 60 A.

3. The lattice support structure of claim 1, wherein semi-rigid mold has a thermal expansion of 200-300 micrometer/m° C.

4. The lattice support structure of claim 1, wherein the semi-rigid mold comprises silicone.

5. The lattice support structure of claim 1, wherein the silicone is a B-stage silicone.

6. The lattice support structure of claim 1, wherein the semi-rigid mold is supported by a mandrel.

7. A method for forming a composite lattice support structure having a plurality of cross supports intersecting one another to form a plurality of multi-layered nodes, the method comprising:
obtaining a semi-rigid mold having a plurality of semi-rigid channels, at least some of the plurality of semi-rigid channels intersecting at strategic locations;
laying up a fiber material uni-directionally, in the presence of a resin, within the semi-rigid channels; and
consolidating the lay-up to form a plurality of composite cross supports having a pre-determined lateral cross-sectional area controlled by a cross-sectional area of the channels, and that intersect to form a plurality of nodes,
the channels containing the lay-up during the consolidating, and facilitating formation of the cross supports and multi-layered nodes.

8. The method of claim 7, wherein the consolidating comprises:
wrapping the lay-up with a polymeric material under tension; and
subjecting the lay-up to an elevated temperature for a given time to cause thermal expansion of the semi-rigid mold and negative thermal expansion of the polymeric material about the fiber material, thereby pressurizing the lay-up,
wherein the pressure compacts the fiber material into the channels, and causes the fiber material to assume a geometry of the channels.

9. The method of claim 8, wherein the wrapping comprises wrapping with a first polymeric material and a second polymeric material.

10. The method of claim 9, wherein the first polymeric material is wrapped first around the lay-up and functions as a release layer.

11. The method of claim 9, wherein the second polymeric material is wrapped around the first polymeric material.

12. The method of claim 7, further comprising subjecting the composite lattice support structure to a finishing process comprising:
disposing the composite lattice support structure at least partially within a particulate; and
systematically rotating the lattice support structure to cause the particulate to simultaneously impinge multiple surfaces of the cross supports and nodes, thereby reducing at least of portion of material on the surfaces.

14. The method of claim 7, wherein the lay-up is subjected to an elevated temperature for a given time sufficient to cause bulging and spreading of the fiber materials at the multi-layered node, thereby enhancing the void content at the nodes.

15. The method of claim 14, wherein the void content at the nodes is between 2%-5%.

16. The method of claim 7, wherein the semi-rigid mold comprises a plurality of channels in the form of grooves formed in a working surface, the grooves defining a number, an orientation, a location and a density of the cross supports and the nodes as part of the formed composite lattice support structure.

17. The method of claim 7, wherein the semi-rigid mold is supported by a rigid mandrel.

18. The method of claim 17, wherein the rigid mandrel is a collapsible mandrel, and wherein the method further comprises collapsing the mandrel to facilitate removal of the formed lattice support structure from the semi-rigid mold after consolidation.

19. The method of claim 17, further comprising placing a release liner between the rigid mandrel and the semi-rigid mold.

20. The method of claim 19, wherein the release liner comprises paper or a polymeric material.

21. The method of claim 7, wherein the channels of the semi-rigid mold comprise a specific, pre-determined cross-sectional area that provide the cross supports with a corresponding cross-sectional area.

22. The method of claim 7, wherein the laying up a fiber material comprises depositing fiber filaments within the channels in a unidirectional orientation through at least some of the channel intersections so the fiber materials maintain a unidirectional path through the formed nodes.

23. The method of claim 7, wherein the laying up a fiber material, in the presence of a resin, prior to consolidation and in an uncured state, provides a seamless three-dimensional green lattice support structure prior to the consolidating.

24. The method of claim 7, wherein the laying up a fiber material, in the presence of a resin, comprises winding a fiber-based tow onto the semi-rigid mold in accordance with a pre-determined winding process, the channels providing a secure pathway for the tow.

25. The method of claim 24, wherein the fiber-based tow comprises a preimpregnated tow.

26. The method of claim 7, wherein the laying up a fiber material includes laying up the fiber material above the working surface of the semi-rigid mold.

27. The method of claim 7, further comprising forming a plurality of multi-layered nodes from layered or overlapping fiber filaments of at least two cross supports selected from the group consisting of non-straight cross supports, helical cross supports, longitudinal cross supports, axial cross supports and lateral or circumferential cross supports.

28. The method of claim 7, wherein obtaining the semi-rigid mold further comprises subjecting the semi-rigid mold to a cutting process to form the channels in the working surface.

29. A method for preparing a green composite three-dimensional lattice preform configuration for use in forming a seamless three-dimensional geometric lattice support structure, the method comprising:
obtaining a semi-rigid mold having one or more channels associated therewith, at least some of which intersect;
obtaining a fiber material;
depositing the fiber material, in the presence of a resin, onto the semi-rigid mold within the channels in a unidirectional orientation, wherein the fiber materials maintain a unidirectional path through the formed nodes;
causing at least some of the fiber materials to be oriented in a three-dimensional orientation about a centerline; and
causing one or more of the fiber materials to intersect and layer to form a lattice structure, and to form a plurality of multi-layered nodes.

30. The method of claim 29, wherein the depositing the fiber material includes depositing the fiber material above the surface of the semi-rigid mold.

31. A system for forming complex three-dimensional composite lattice support structures, the system comprising:
a semi-rigid mold having a plurality of channels, at least some of the plurality of channels intersecting at strategic locations;
a lay-up of fiber material, in the presence of a resin, within the channels, the fiber material comprising fiber filaments that are layered with one another and that intersect at the strategic locations; and
a curing system for consolidating the lay-up to form a plurality of cross supports and multi-layered nodes.

32. The system of claim 31, wherein the curing system comprises:
at least one layer of a polymeric material applied under tension to the lay-up and the semi-rigid mold; and
an elevated temperature to effect thermal expansion of the semi-rigid mold and negative thermal expansion of the polymeric material, wherein the lay-up is pressurized sufficiently to compact the fiber materials into the channels, and to cause the fiber material to assume a geometry of the channels.

33. The system of claim 32, wherein the wrapping comprises wrapping with a first polymeric shrink material and a second polymeric shrink material.

34. The system of claim 33, wherein the first polymeric shrink material is wrapped first around the lay-up and functions as a release layer.

35. The system of claim 33, wherein the second polymeric shrink material is wrapped around the first polymeric shrink material.

36. The system of claim 33, wherein the first polymeric shrink material is a polyethylene polymer.

37. The system of claim 33, wherein the second polymeric shrink material is a nylon-based polymer.

38. The system of claim 31, wherein the semi-rigid mold comprises an extension member adjacent an opening of at least one of the channels.

39. The system of claim 31, wherein the semi-rigid mold has a Shore A hardness of between 40 A to 60 A.

40. The system of claim 31, wherein semi-rigid mold has a thermal expansion of 200-300 micrometer/m° C.

41. The system of claim 31, wherein the semi-rigid mold comprises silicone.

42. The system of claim 41, wherein the silicone is a B-stage silicone.

43. The system of claim 31, further comprising a rigid mandrel configured to support the semi-rigid mold and lay-up.

44. The system of claim 31, further comprising a finishing system for finishing the lattice support structure after consolidating, the finishing system comprising:
a container; and
a particulate contained within the container, wherein the container is configured to receive the composite lattice support structure at least partially within the particulate; and
a rotating mechanism in support of the lattice support structure, the rotating mechanism being configured to systematically rotate the lattice support structure to cause the particulate to simultaneously impinge multiple surfaces of the cross supports and nodes, thereby reducing at least of portion of material on the surfaces.

45-101. (canceled)
